(19) United States
(12) Patent Application Publication
(10) Pub. No.: US 2005/0245399 A1
(43) Pub. Date: Nov. 3, 2005

(54) Pyrazole derivatives as herbicidal compositions containing them

(75) Inventors: Hiroshi Shimoharada, Kusatsu-shi (JP); Masamitsu Tsukamoto, Kusatsu-shi (JP); Hiroshi Kikugawa, Kusatsu-shi (JP); Yoshinori Kitahara, Kusatsu-shi (JP)

Correspondence Address: SUGHRUE MION, PLLC, 2100 PENNSYLVANIA AVENUE, N.W., SUITE 800, WASHINGTON, DC, 20037, US

(73) Assignee: ISHIHARA SANGYO KAISHA, LTD.

(21) Appl. No.: 10/834,028

(22) Filed: Apr. 29, 2004

(51) Int. Cl. A01N 43/56; A01N 43/40

(52) U.S. Cl. 504/282; 548/366.1; 548/367.4

(57) ABSTRACT

The present invention relates to novel pyrazole derivatives of the formula (I) or its salt: 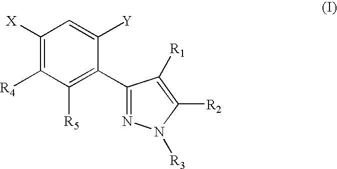
wherein X, Y, R₁, R₂, R₃, R₄ and R₅ each have one of the meanings given in the description, a process for producing them, and their use as herbicides, desiccants or defoliants.

### BACKGROUND OF THE INVENTION

1. Field of the Invention

The present invention relates to novel pyrazole derivatives or their salts, a process for producing them, and their use as herbicides, desiccants or defoliants.

2. Description of the Related Art

WO96/15115, WO01/85907, WO99/21837 and WO00/13508 disclose the herbicidal utility of pyrazole derivatives.

Despite the broad coverage of these patents, the specific pyrazole compounds of the formula I mentioned below are novel and can be used to effectively control a variety of broad or grassy leaf plant species.

### SUMMARY OF THE INVENTION

The present invention delineates a method for the control of undesired vegetation in a plantation crop by the application to the locus of the crop an effective amount of a compound described herein. The present invention provides certain herbicidal pyrazole derivatives of the formula I including all geometric, tautomeric and stereo isomers, and their salts, as well as compositions containing them, methods of preparation for these compounds and intermediates for these compounds.

The herbicidal compounds of the present invention described by the following formula I or its salt: 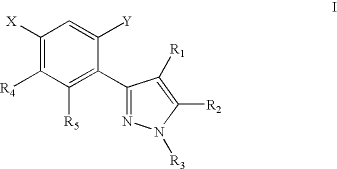
wherein
X and Y are independent of each other and are selected from the group consisting of halogen, cyano, nitro, (C₁₋₆)alkyl, (C₁₋₆)haloalkyl, (C₁₋₆)alkoxy and (C₁₋₆)haloalkoxy;
R₁ is hydrogen, halogen, cyano, nitro, (C₁₋₆)alkyl, (C₁₋₆)haloalkyl, (C₁₋₆)alkoxy or (C₁₋₆)haloalkoxy;
R₂ is (C₁₋₆)haloalkoxy;
R₃ is (C₁₋₆)alkyl, (C₁₋₆)haloalkyl, (C₁₋₆)alkoxy or (C₁₋₆)haloalkoxy;
R₄ is selected from the group consisting of halogen, cyano, nitro, hydroxy, carboxyl, formyl, isocyanate, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((C₂₋₆)alkynylthio)thiocarbonyl, (C₁₋₆)alkylcarbonyloxy, (C₂₋₆)alkenylcarbonyloxy, (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy, ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy, ((C₂₋₆)alkynyl)thiocarbonyloxy, ((C₁₋₆)alkoxy)thiocarbonyloxy, ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₁₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₂₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₆)alkynylthio)thiocarbonylthio, (C₂₋₆)alkenylsulfonyloxy, (C₂₋₆)alkynylsulfonyloxy, (C₃₋₆)cycloalkyl, (C₃₋₆)cycloalkenyl, (C₃₋₆)cycloalkyloxy, (C₃₋₆)cycloalkenyloxy, (C₃₋₆)cycloalkylthio, (C₃₋₆)cycloalkenylthio, (C₃₋₆)cycloalkylsulfinyl, (C₃₋₆)cycloalkenylsulfinyl, (C₃₋₆)cycloalkylsulfonyl, (C₃₋₆)cycloalkenylsulfonyl, (C₃₋₆)cycloalkylcarbonyl, (C₃₋₆)cycloalkenylcarbonyl, aryl, aryloxy, arylcarbonyl, aryloxycarbonyl, (arylthio)carbonyl, arylthio, arylsulfinyl, arylsulfonyl, heterocyclyl, heterocyclyloxy, heterocyclylcarbonyl, heterocyclyloxycarbonyl, (heterocyclylthio)carbonyl, heterocyclylthio, heterocyclylsulfinyl, heterocyclylsulfonyl, —CR₆═NOR₇, —CONR₇R₈, —CO₂NR₇R₈, —NR₆NR₇R₈, —NR₆N═CR₇R₈ and —N═CR₇R₈,
where any of these groups may be substituted with one or more of the groups selected from the group consisting of halogen, cyano, nitro, amino, carboxyl hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, (C₁₋₆)alkylsulfinylcarbonyl, (C₁₋₆)haloalkylsulfinylcarbonyl, (C₁₋₆)alkylsulfonylcarbonyl, (C₁₋₆)haloalkylsulfonylcarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl and heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, amino, (C₁₋₆)alkylamino and di(C₁₋₆)alkylamino (herein after referred to simply as SUBSTITUENT GROUP I);
R₅ is selected from the group consisting of halogen, cyano, nitro, carboxyl, formyl, isocyanate, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₁₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((c₂₋₆)alkynylthio)thiocarbonyl, (C₁₋₆)alkylcarbonyloxy, (C₂₋₆)alkenylcarbonyloxy, (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy, ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy; ((C₂₋₆)alkynyl)thiocarbonyloxy, ((C₁₋₆)alkoxy)thiocarbonyloxy, ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₂₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₂₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₆)alkynylthio)thiocarbonylthio, (C₁₋₆)alkylsulfonyloxy, (C₂₋₆)alkenysulfonyloxy, (C₂₋₆)alkynylsulfonyloxy, (C₃₋₆)cycloalkyl, (C₃₋₆)cycloalkenyl, (C₃₋₆)cycloalkyloxy, (C₃₋₆)cycloalkenyloxy, (C₃₋₆)cycloalkylthio, (C₃₋₆)cycloalkenylthio, (C₃₋₆)cycloalkylsulfinyl, (C₃₋₆)cycloalkenylsulfinyl, (C₃₋₆)cycloalkylsulfonyl, (C₃₋₆)cycloalkenylsulfonyl, (C₃₋₆)cycloalkylcarbonyl, (C₃₋₆)cycloalkenylcarbonyl, aryl, aryloxy, arylcarbonyl, aryloxycarbonyl, (arylthio)carbonyl, arylthio, arylsulfinyl, arylsulfonyl, heterocyclyl, heterocyclyloxy, heterocyclylcarbonyl, heterocyclyloxycarbonyl, (heterocyclylthio)carbonyl, heterocyclylthio, heterocyclylsulfinyl, heterocyclylsulfonyl, —CR₆═NOR₇, —CONR₇R₈, —CO₂NR₇R₈, —NR₇R₈, —NR₆NR₇R₈, —CO₂N═CR₇R₈, —NR₆N═CR₇R₈, —N═CR₇R₈ and —CO(halogen),
where any of these groups may be substituted with one or more of the groups selected from SUBSTITUENT GROUP I;
R₆, R₇ and R₈ are independent of each other and are selected from the group consisting of hydrogen, halogen, cyano, nitro, amino, carboxyl, formyl, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((C₂₋₆)alkynylthio)thiocarbonyl, aminocarbonyl, (C₁₋₆)alkylaminocarbonyl, di(C₁₋₆)alkylaminocarbonyl, (amino)thiocarbonyl, ((C₁₋₆)alkylamino)thiocarbonyl, (di(C₁₋₆)alkylamino)thiocarbonyl, (C₁₋₆)alkylcarbonyloxy, (C₂₋₆)alkenylcarbonyloxy, (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy, ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy, ((C₂₋₆)alkynyl)thiocarbonyloxy, ((C₁₋₆)alkoxy)thiocarbonyloxy, ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₂₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₁₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₄)alkynylthio)thiocarbonylthio, (C₃₋₆)cycloalkyl, (C₃₋₆)cycloalkenyl, (C₃₋₆)cycloalkylsulfinyl, (C₃₋₆)cycloalkenylsulfinyl, (C₂₋₆)cycloalkylsulfonyl, (C₃₋₆)cycloalkenylsulfonyl, (C₃₋₆)cycloalkylcarbonyl, (C₃₋₆)cycloalkenylcarbonyl, aryl, aryloxy, arylthio, arylsulfinyl, arylsulfonyl, arylcarbonyl, heterocyclyl, heterocyclyloxy, heterocyclylsulfinyl, heterocyclylsulfonyl, heterocyclylcarbonyl, —CO₂N═CRaRb, —CO—W-Q, —CO—(CH₂)ₘ—W-Q, —CO—W—(CH₂)ₘ-Q and —CO—CH₂)ₘ—W—(CH₂)ᵣ-Q,
where any of these groups may be substituted with one or more of the groups selected from the group consisting of halogen, cyano, nitro, amino, (C₁₋₆)alkylamino, (C₁₋₆)dialkylamino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl and heterocyclylcarbonyl wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino (herein after referred to simply as SUBSTITUENT GROUP II);
when R₇ and R₈ are taken together with the atoms to which they are attached, they represent a four to seven membered substituted or unsubstituted ring optionally containing C(O), O, S, S(O), S(O)₂ or N with following optional substitutions, one to three halogen, cyano, nitro, amino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl or heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino;
wherein
Ra and Rb are independent of each other and are selected from the group consisting of hydrogen, (C₁₋₆)alkyl, (C₁₋₆)haloalkyl and aryl, when Ra and Rb are taken together with atoms to which they are attached they represent a four to seven membered saturated ring;
W is oxygen, sulfur or —NRc;
Rc is hydrogen or (C₁₋₆)alkyl;
Q is aryl or heterocyclyl, wherein the aryl and the heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino;
m is integer from 1 to 6;
r is integer from 1 to 6;
with proviso that 4-chloro-3-(2-amino-4-chloro-6-fluoro-3-hydroxyphenyl)-5-difluoromethoxy-1-methyl-1H-pyrazole, N-[3-chloro-6-[4-chloro-5-(difluoromethoxy)-1-methyl-1H-pyrazol-3-yl]-5-fluoro-2-methoxyphenyl]-benzamide and [3-chloro-6-[4-chloro-5-(difluoromethoxy)-1-methyl-1H-pyrazol-3-yl]-5-fluoro-2-methoxyphenyl]-carbamic acid (3-nitrophenyl)methyl ester are excluded.

In the definitions given above, halogen, alkyl, alkenyl, alkynyl, cycloalkyl, cycloalkenyl, aryl and heterocyclyl are defined or mentioned herein after.

The halogen or halogen as a substituent, each atom of fluorine, chlorine, bromine or iodine may be mentioned. The number of halogens as substituents may be 1 or more, and if more, the respective halogens may be the same or different. Further, the positions for substitution of halogens may be any positions.

The alkyl or alkyl moiety may be linear or branched, and as its specific example, (C₁₋₆)alkyl such as methyl, ethyl, propyl, isopropyl, butyl, tert-butyl, pentyl or hexyl may be mentioned. The alkenyl or alkenyl moiety may be linear or branched, and its specific example, (C₂₋₆)alkenyl, such as vinyl, 1-propenyl, allyl, isopropenyl, 1-butenyl, 1,3-butadienyl or 1-hexenyl may be mentioned. The alkynyl or alkynyl moiety may be linear or branched, and as its specific example, (C₂₋₆)alkynyl such as ethynyl, 2-butynyl, 2-pentynyl or 3-hexynyl may be mentioned. The cycloalkyl or cycloalkyl moiety (C₃₋₆)cycloalkyl such as cyclopropyl, cyclobutyl, cyclopentyl or cyclohexyl may be mentioned. The cycloalkenyl or cycloalkenyl moiety, (C₃₋₆)cycloalkenyl such as cyclopropenyl, cyclobutenyl, cyclopentenyl or cyclohexenyl may be mentioned.

The term or part of the term “aryl” is defined as those monocyclic or fused bicyclic rings, examples include: phenyl, naphthyl, etc. The term or part of term “heterocyclyl” is defined as those monocyclic or fused bicyclic rings containing 1 to 4 heteroatoms, which are saturated or unsaturated, examples include: tetrahydrofuranyl, tetrahydropyranyl, piperidinyl, morpholinyl, furyl, furazanyl, thienyl, pyrrolyl, pyrazolyl, oxazolyl, oxadiazolyl, imidazolyl, isoxazolyl, thiazolyl, thiadiazolyl, isothiazolyl, tetrazolyl, pyridinyl, pyrimidinyl, pyridazinyl, pyrazinyl, triazinyl, quinolyl, isoquinolyl, quinoxalinyl, benzofuranyl, 2,3-dihydrobenzofuranyl, isobenzofuranyl, benzothienyl, benzodioxolyl, chromanyl indolinyl, isoindolyl, thienofuranyl, purinyl, etc. These rings can attached through any available carbon or nitrogen, for example, when the ring system is furyl, it can be 2-furyl or 3-furyl for pyrrolyl the aromatic ring system is 1-pyrrolyl, 2-pyrrolyl or 3-pyrrolyl, for naphthyl, the carbobicyclic aromatic ring is 1-naphthyl or 2-naphthyl and for benzofuranyl, the aromatic ring system can be 2-, 3-, 4-, 5-, 6- or 7-benzofuranyl.

The salt of the pyrazole derivatives of the formula I includes all kinds so long as they are agriculturally acceptable. For example, an alkali metal salt such as a sodium salt or a potassium salt; an alkaline earth metal salt such as a magnesium salt or a calcium salt; an ammonium salt such as a dimethylamine salt or a triethylamine salt; an inorganic acid salt such as a hydrochloride, a perchlorate, a sulfate or a nitrate; or an organic acid salt such as an acetate or a methanesulfonate, may be mentioned.

Preferred compounds for the reasons of greater herbicidal efficacy are
X and Y are independent of each other and are selected from the group consisting of halogen and cyano,
R₁ is halogen, cyano, (C₁₋₆)haloalkyl or (C₁₋₆)haloalkoxy;
R₂ is (C₁₋₆)haloalkoxy;
R₃ is (C₁₋₆)alkyl;
R₄ is halogen, cyano, nitro, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkoxycarbonyl, (C₁₋₆)alkylcarbonyloxy, (C₃₋₆)cycloalkyl, (C₃₋₆)cycloalkylcarbonyl, aryloxy or heterocyclyloxy,
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy.

More preferred compounds for the reasons of greater herbicidal efficacy are
X and Y are independent of each other and are selected from the group consisting of halogen and cyano;
R₁ is halogen, cyano, (C₁₋₆)haloalkyl or (C₁₋₆)haloalkoxy;
R₂ is (C₁₋₆)haloalkoxy;
R₃ is (C₁₋₆)alkyl
R₄ is halogen, cyano, nitro, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkoxycarbonyl, (C₁₋₆)alkylcarbonyloxy, (C₃₋₆)cycloalkyl, (C₃₋₆)cycloalkylcarbonyl, aryloxy or heterocyclyloxy,
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy;
R₅ is halogen, cyano, nitro, carboxyl, formyl, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₁₋₆)alkoxycarbonyl, (C₁₋₆)alkylcarbonyloxy, (C₃₋₆)cycloalkyl, (C₃₋₆)cycloalkylcarbonyl, aryloxy, arylsulfonyl, heterocyclyloxy, —CONR₇R₈, —NR₇R₈, —N═CR₇R₈, —CO₂N—CR₇R₈ or —CO(halogen),
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy;
R₇ and R₈ are independent of each other and are selected from the group consisting of hydrogen, halogen, cyano, nitro, amino, carboxyl, formyl, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₁₋₆)alkenylcarbonyl, (C₁₋₆)alkoxycarbonyl, (C₁₋₆)alkynyloxycarbonyl, ((C₁₋₆)alkylthio)carbonyl, ((C₁₋₆)alkyl)thiocarbonyl, ((C₁₋₆)alkoxy)thiocarbonyl, aminocarbonyl, (C₁₋₆)alkylaminocarbonyl, di(C₁₋₆)alkylaminocarbonyl, (amino)thiocarbonyl, ((C₁₋₆)alkylamino)thiocarbonyl, (di(C₁₋₆)alkylamino)thiocarbonyl, (C₁₋₆)alkylcarbonyloxy, (C₃₋₆)cycloalkyl, (C₃₋₆)cycloalkylcarbonyl, aryl, aryloxy, arylthio, arylsulfinyl, arylsulfonyl, arylcarbonyl, heterocyclyl, heterocyclyloxy, heterocyclylcarbonyl, —CO₂N═CRaRb, —CO—W-Q, —CO—(CH₂)ₘ—W-Q, —CO—W—(CH₂)ₘ-Q and —CO—(CH₂)ₘ—W—(CH₂)ᵣ-Q,
where any of these groups may be substituted with one or more of the following group consisting of halogen, cyano, nitro, amino, (C₁₋₆)alkylamino, (C₁₋₆)dialkylamino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen cyano, nitro, (C₁₋₆)alkyl and (C₁₋₆)alkoxy,
when R₇ and R₈ are taken together with the atoms to which they are attached, they represent a four to seven membered substituted or unsubstituted ring optionally containing C(O), O, S, S(O), S(O) or N.

### DETAILED DESCRIPTION OF THE INVENTION

The compounds described by the formula I can be prepared by the procedures as described herein. Using commercially available starting materials or those whose synthesis is known in the art, the compounds of this invention may be prepared using methods described in the following Schemes, or using modifications thereof, which are within the scope of the art.

The starting compounds represented by formula II in Scheme 1 can be prepared according to the literature procedure (e.g. EP 0 361 114, DE 19 622 189 and WO 92/02509). The nitro derivatives represented by formula III can be prepared analogously by known method (WO99/21837). The reaction can be carried out by its slow addition to a mixed solvent of sulfuric acid and nitric acid with or without co-solvent such as 1,2-dichloroethane at a temperature between −30° C. and 80° C. for 0.5 to 5 hours. An inorganic salt such as ammonium nitrate can be used instead of nitric acid, Compounds of formula III can be converted to the corresponding aniline derivatives represented by formula IV by typical reduction procedures e.g. iron in an acidic medium such as acetic acid or by catalytic hydrogenation. Amide derivatives represented by formula of V can be prepared from compounds of formula IV by a coupling reaction with acid halides or acid anhydrides. The reaction can be carried out with or without base such as triethylamine, diisopropylethylamine, pyridine or N,N-dimethylaminopyridine (DMAP) in an inert solvent such as tetrahydrofuran (THF), acetonitrile or 1,4-dioxane at a temperature between −5° C. and 150° C. for 0.5 to 48 hours.

In Scheme 1, R_{d} is alkyl, alkenyl, alkynyl, alkoxy, alkenyloxy, alkynyloxy, alkylthio, alkenylthio, alkynylthio, amino, alkylamino, dialkylamino, cycloalkyl, cycloalkenyl, aryl, heterocyclyl, —O—N═CRₐR_{b}, —W-Q, —(CH₂)ₘ, —W-Q, —W—(CH₂)ₘ-Q or —(CH₂)ₘ—W—(CH₂)ᵣ-Q, wherein Rₐ, R_{b}, W, Q, m and r are as defined above. Further, any of these groups may be substituted with one or more of the group(s) selected from the SUBSTITUENT GROUP II.

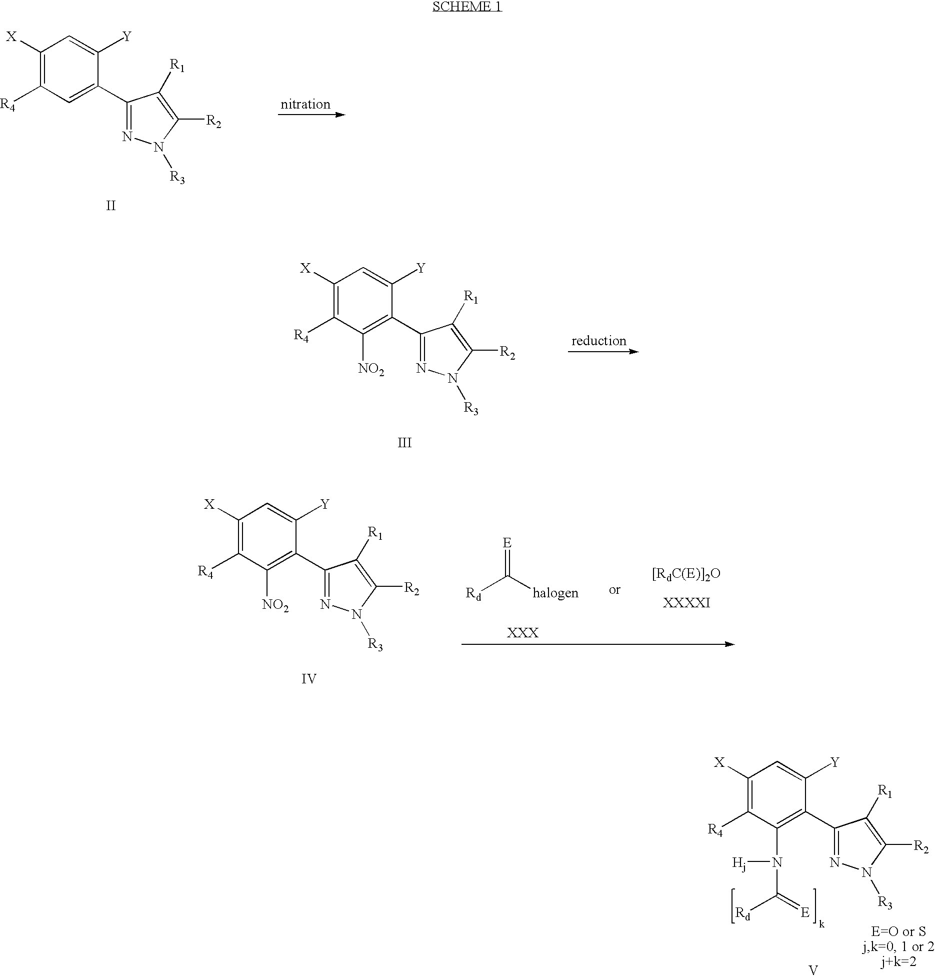

The compounds represented by formula VI in Scheme 2 can be prepared from compounds of formula IV by using phosgene or related reagent such as thiophosgene or triphosgene with or without base such as triethylamine, diisopropylethylamine or pyridine. The reaction can be carried out in an inert solvent such as ethyl acetate or toluene at a temperature between −10° C. and 150° C. for 0.5 to 24 hours. The final compounds represented by formula VII can be prepared from compounds of formula VI by treatment with the corresponding alcohol or thioalcohol represented by formula VIII in an inert solvent such as dichloromethane, THF or toluene. The reaction can be carried out with or without base such as triethylamine at a temperature between −10° C. and 100° C. for 0.5 to 24 hours.

In Scheme 2, Rₐ is alkyl, alkenyl, alkynyl, —N═CRₐR_{b}, -Q or —(CH₂)ₘ-Q, wherein Rₐ, R_{b}, Q and m are as defined above. Further, any of these groups may be substituted with one or more of the group(s) selected from the SUBSTITUENT GROUP II.

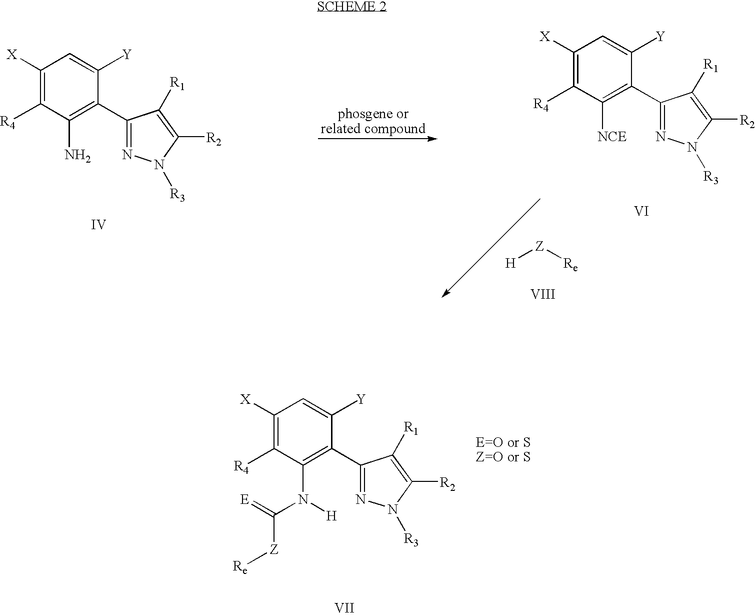

Urea derivatives represented by formula IX in Scheme 3 can be prepared from compounds of formula VI by treatment with the corresponding amino derivatives represented by formula X in an inert solvent such as toluene, 2-butene or THF. The reaction can be carried out with or without base such as triethylamine or 1,8-diazabicyclo[5.4.0]undec-7-ene (DBU) at a temperature between 0° C. and 100° C. for 0.5 to 24 hours.

In Scheme 3, R_{f} and R_{g} are independent hydrogen, alkyl, -Q or —(CH₂)ₘ-Q, wherein Q and m are as defined above. Further, any of these groups may be substituted with one or more of the group(s) selected from the SUBSTITUENT GROUP II.

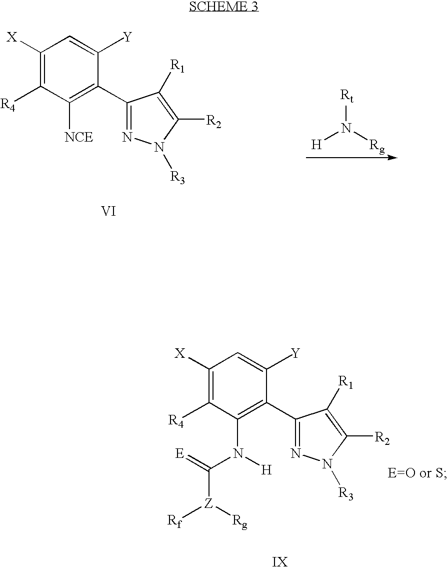

Formamide derivatives represented by formula XI in Scheme 4 can be prepared from compounds of formula IV by a formylation reaction. The reaction can be carried out in the presence of formic acid at a temperature between 0° C. and 150° C. for 0.5 to 48 hours. Compounds of formula XI can be convened into the corresponding derivatives represented by formula XII. The reaction can be carried out typically by treatment with compounds of formula R₇-L (L=leaving group such as halogen, methanesulfonyl, methanesulfonyloxy, p-toluenesulfonyloxy, trifluoromethanesulfonyloxy or methoxysulfonyloxy) in the presence of base such as sodium hydride in an inert solvent such as TBS, N,N-dimethylformamide (DMF) or dimethylsulfoxide (DMSO) at a temperature between 0° C. and 150° C. for 0.5 to 24 hours. Compounds of formula XII can be converted into the corresponding amine derivatives represented by formula XIII by a deprotection reaction. The formyl group can be removed by treatment with an acid such as hydrochloric acid or an inorganic base such as sodium hydroxide in a polar solvent such as water, methanol, DMF or 1,4-dioxane. The reaction can be carried out at a temperature between 0° C. and 150° C. for 0.5 to 48 hours. The solvent was removed under reduced pressure) and then purified.

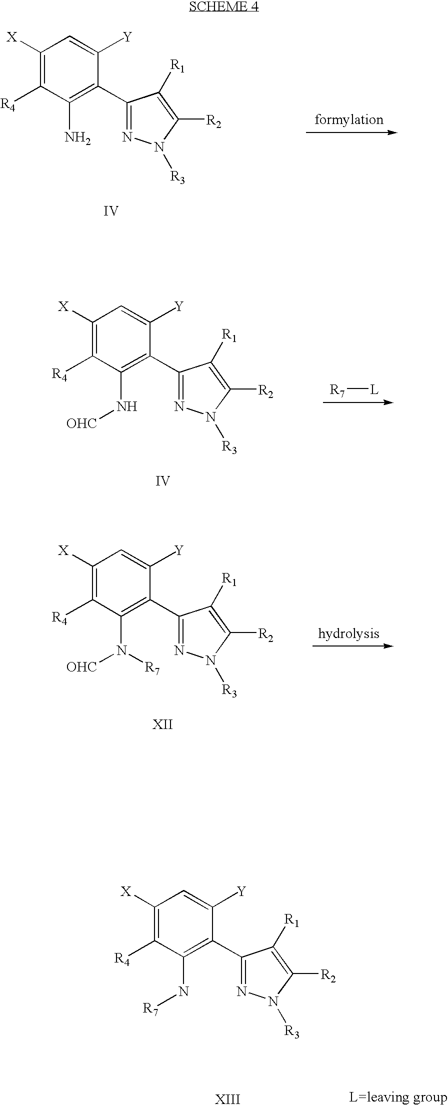

Hydrazine derivatives represented by formula XV in Scheme 5 can be prepared from compounds of formula IV through diazonium salt derivatives represented by formula XIV according to the literature procedure (e.g. Org. Synth., I, 442). Hydrazone derivatives represented by formula XVI can be prepared analogously by known method (e.g. Org Synth., IV, 12). The compounds represented by formula XVII can be prepared from compounds of formula XVI by treatment with an electrophile such as methyl iodide or acetyl chloride. The reaction can be carried out with or without base such as triethylamine or sodium hydride in an inert solvent such as THF, DMF or DMSO at a temperature between 0° C. and 150° C. for 0.5 to 48 hours. Compounds of formula XVIII can be prepared from compounds of formula XVII by typical reduction procedure. The reaction can be carried out in the presence of reducting reagent such as sodium borohydride in an inert solvent such as methanol at a temperature between 0° C. and 150° C. for 0.5 to 24 hours.

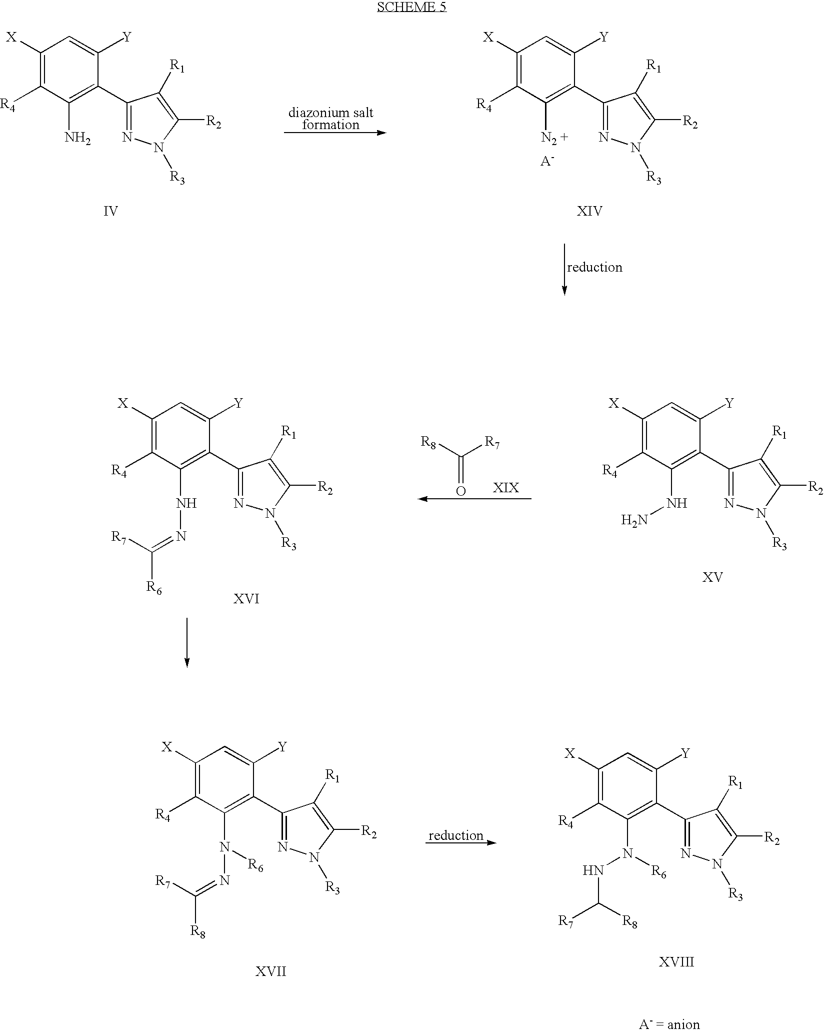

The compounds represented by formula XX in Scheme 6 can be prepared from compounds of formula IV by treatment with compounds of formula XIX. The reaction can be carried out with or without catalyst such as p-toluenesulfonic acid or acetic acid in an inert solvent such as benzene or toluene at a temperature between 0° C. and 200° C. for 0.5 to 48 hours.

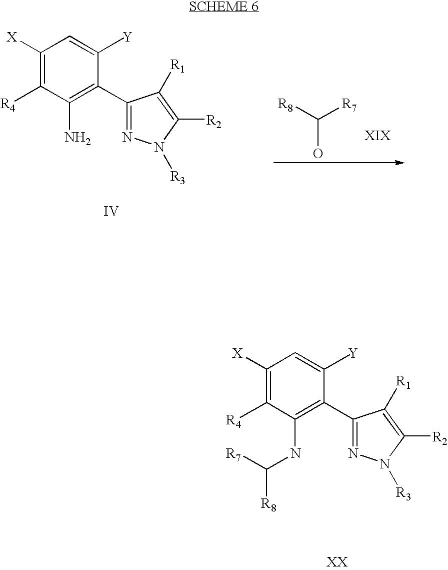

Benzaldehydes represented by formula XXI in Scheme 7 can be prepared from compounds of formula XIV according to the literature procedure (e.g. Org. Synth., V, 139). Compounds of formula XXI can be converted into the corresponding acid derivatives represented by formula XXII by treatment with an oxidizing reagent such as chromium trioxide. The reaction can be carried out in an acidic medium such as diluted sulfuric acid with or without co-solvent such as acetone at a temperature between −10° C. and 150° C. for 0.5 to 48 hours. Compounds of formula XXII can be converted into the corresponding acid halides by treatment with thionyl chloride, phosphorous trichloride, phosphorous pentachloride or oxalyl chloride with or without solvent such as chloroform. The reaction can be carried out with or without catalyst such as DMF at a temperature between 0° C. and 150° C. for 0.5 to 48 hours. The final compounds represented by formula XXIII can be prepared from the corresponding acid chlorides by a coupling reaction with compounds of formula VIII′. The reaction can be carried out with or without base such as triethylamine, pyridine or DBU in an inert solvent such as THF at a temperature between −10° C. and 150° C. for 0.5 to 48 hours. The solvent was removed under reduced pressure, and then purified.

In Scheme 7, Rₕ is alkyl, alkenyl, alkynyl, aryl, heterocyclyl, —NR₇R₈ or —N═CR₇R₈, wherein R₇ and R₈ are as defined above. Further, any of these groups may be substituted with one or more of the group(s) selected from the SUBSTITUENT GROUP I.

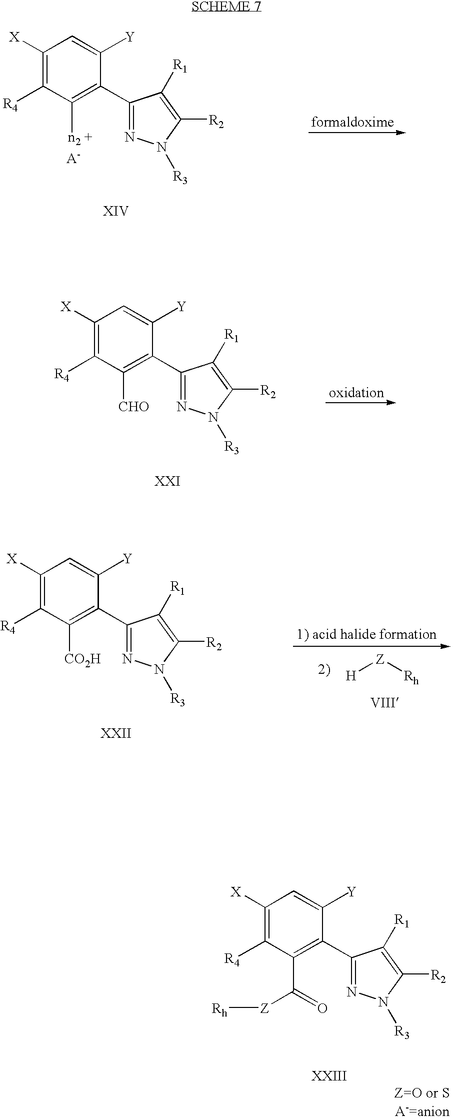

Sulfide derivatives represented by formula XXIV in Scheme 8 can be prepared analogously by known method (e.g. WO 99/21837). Compounds of formula XXIV can be further modified according to conventional method (e.g. Org. Synth., VII, 453). The reaction can be carried out in the presence of oxidant such as m-chloroperbenzoic acid or hydrogen peroxide in an inert solvent such as chloroform at a temperature between −10° C. and 150° C. for 0.5 to 48 hours.

In Scheme 8, Rᵢ is alkyl, alkenyl, alkynyl, cycloalkyl, cycloalkenyl, aryl or heterocyclyl. Further, any of these groups may be substituted with one or more of the group(s) selected from the SUBSTITUENT GROUP I.

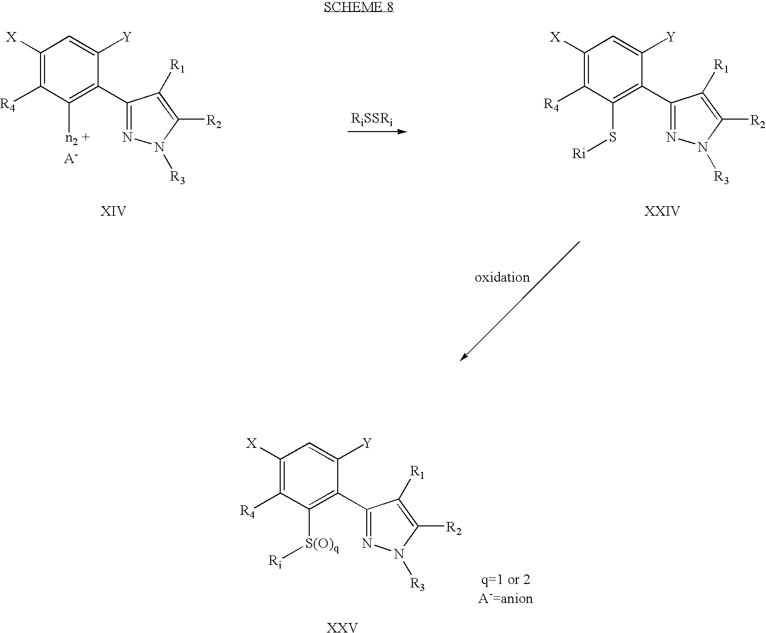

The compounds representative by formula XXVI in Scheme 9 can be prepared from compounds of formula IV according to the literature procedure (e.g. WO 90/02120 or Org. synth., VII, 105). Compounds of formula IV can be treated with a mixture of electron-deficient compound such as ethyl acrylate and nitrate derivative such as tert-butyl nitrate in the presence of metal salt such as copper(II) chloride or titanium trichloride in an inert solvent such as acetonitrile or DMF. The reaction can be carried out at a temperature between −20° C. and 100° C. for 0.5 to 48 hours.

In Scheme 9, Rⱼ is alkyl, alkenyl or alkynyl which may be substituted with one or more of the following group consisting of halogen, cyano, nitro, carboxyl, alkylsulfinyl, haloalkylsulfinyl, alkylsulfonyl, haloalkylsulfonyl, alkylcarbonyl, haloalkylcarbonyl, alkoxycarbonyl, haloalkoxycarbonyl, aryl arylsulfinyl, arylsulfonyl, arylcarbonyl, heterocyclyl, heterocyclylsulfinyl, heterocyclylsulfonyl and heterocyclylcarbonyl, wherein aryl and heterocyclyl are optionally substituted by one or more substituents which are the same or different and selected from the group consisting of halogen, cyano, nitro, carboxyl hydroxy, mercapto, alkyl haloalkyl, alkoxy, haloalkoxy, alkylthio, haloalkylthio, alkylsulfinyl, haloalkylsulfinyl, alkylsulfonyl, haloalkylsulfonyl, amino, alkylamino and dialkylamino.

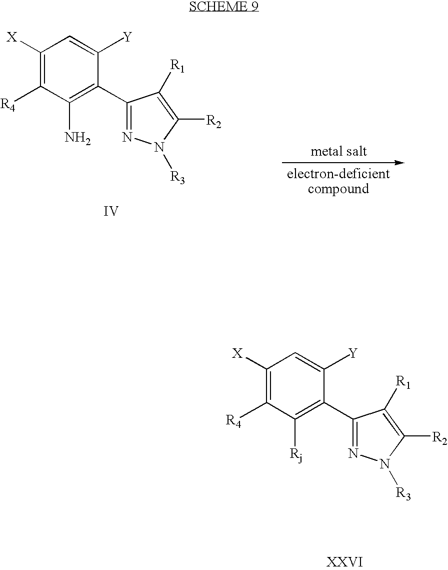

The starting compounds represented by formula XXVII in Scheme 10 can be prepared analogously by known method (e.g. WO00/13508). Compounds of formula XXVII can be converted into the corresponding compounds represented by formula XXVIII by using compounds of formula Rₖ-L in the presence of base such as potassium carbonate or sodium hydride. The reaction can be carried out in an inert solvent such as DMF, acetone, 2-butanone or THF at a temperature between −20° C. and 200° C. for 0.5 to 48 hours.

In Scheme 10, Rₖ is alkyl, alkenyl, alkynyl, alkylcarbonyl, alkenylcarbonyl, alkynylcarbonyl, alkoxycarbonyl, alkenyloxycarbonyl, alkynyloxycarbonyl, (alkylthio)carbonyl, (alkenylthio)carbonyl, (alkynylthio)carbonyl, (alkyl)thiocarbonyl, (alkenyl)thiocarbonyl, (alkynyl)thiocarbonyl, (alkoxy)thiocarbonyl, (alkenyloxy)thiocarbonyl, (alkynyloxy)thiocarbonyl, (alkylthio)thiocarbonyl, (alkenylthio)thiocarbonyl, (alkynylthio)thiocarbonyl, alkylsulfonyl alkenylsulfonyl alkynylsulfonyl, cycloalkyl, cycloalkenyl, aryl or heterocyclyl. Further, any of these groups may be substituted with one or more of the group(s) selected from the SUBSTITUENT GROUP I.

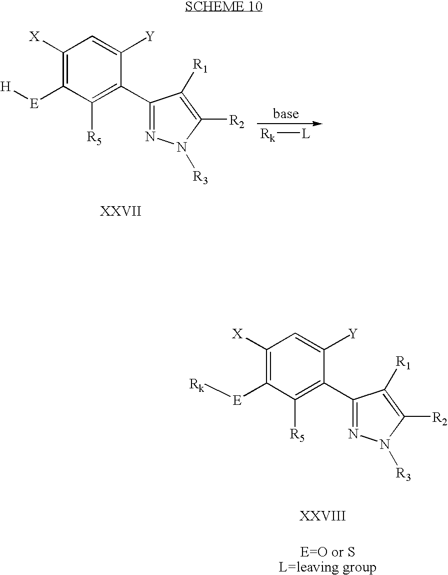

The compounds represented by formula XXIX in Scheme 11 can be prepared from compounds of formula XV according to the general procedure described in Scheme 1. Compounds of formula XV can be treated with an electrophile such as acetyl chloride, ethylchloroformate or acetic anhydride in an inert solvent such as chloroform, THF, toluene, pyridine or 1,4-dioxane. The reaction can be carried out with or without base such as triethylamine or DBU at a temperature between 0° C. and 150° C. for 0.5 to 48 hours.

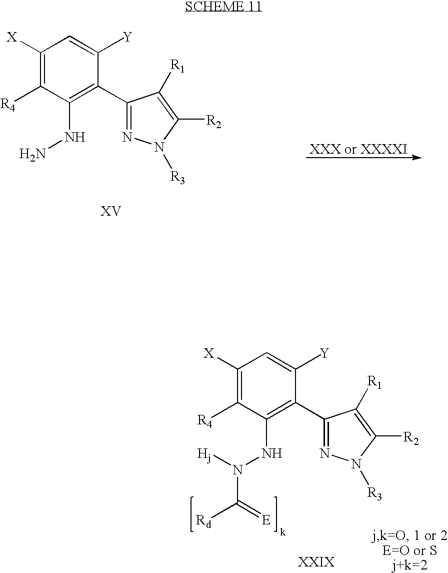

Amide derivatives represented by formula XXXI in Scheme 12 can be prepared from compounds of formula XXII according to the general procedure described in Scheme 7. Compounds of formula XXII can be converted into the corresponding acid halides represented by formula XXXXII by treatment with thionyl chloride, phosphorous trichloride, phosphorous pentachloride or oxalyl chloride. Obtained acid halides can be converted into the amide derivatives represented by formula XXXI by treatment with compounds of formula X in an inert solvent such as or 1,4-dioxane with or without base such as triethylamine or DBU. The reaction can be carried out at a temperature between −30° C. and 150° C. for 0.5 to 48 hours.

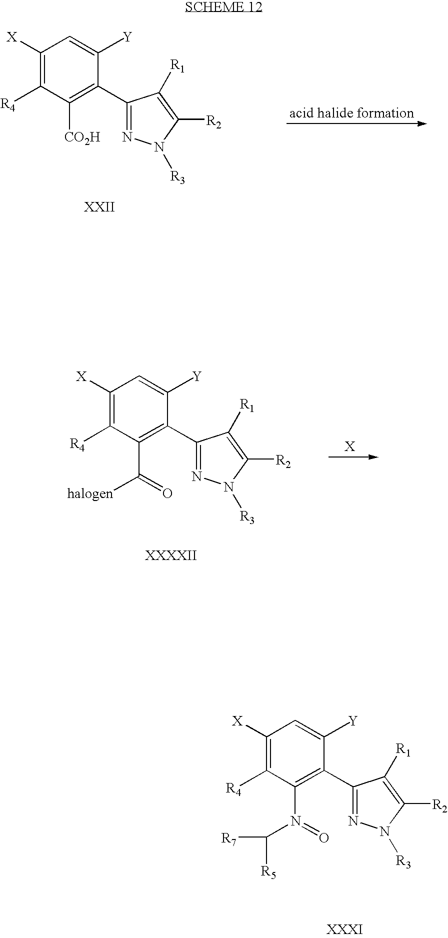

The compounds represented by formulas XXXII, XXXIII, XXXIV and XXXV in Scheme 13 can be prepared from compounds of formulas XIII, IX VII and V′ respectively by a coupling reaction with compounds of formula R₈-L. The reaction can be carried out in an inert solvent such as THF, DMF or 2-butanone with or without base such as triethylamine, DBU, potassium carbonate or sodium hydride at a temperature between −10° C. and 200° C. for 0.5 to 48 hours.

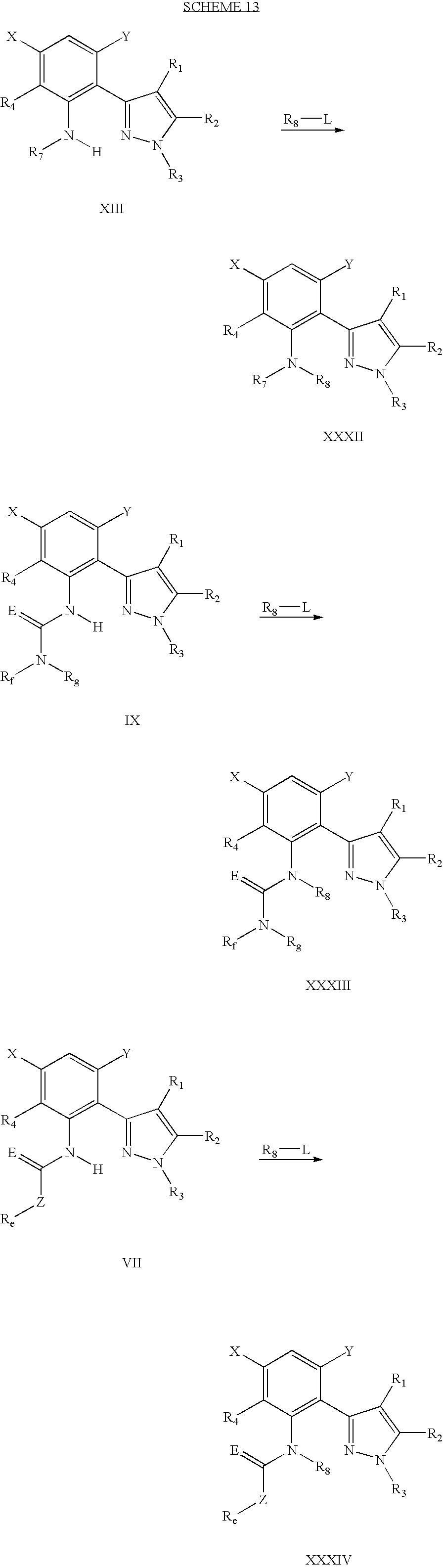

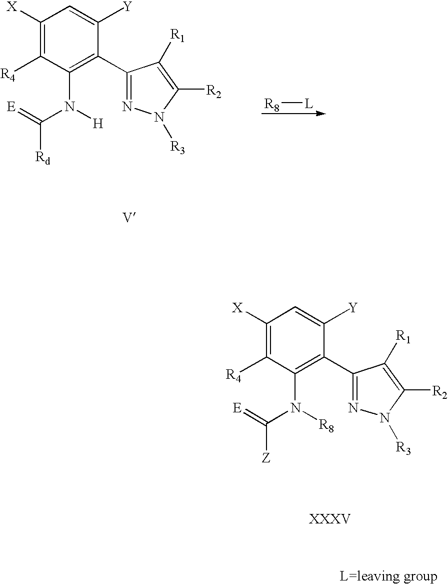

The compounds represented by formula XXXVI in Scheme 14 can be prepared from compounds of formula IV by a coupling reaction with the corresponding sulfonyl halides such as ethanesulfonyl chloride, or anhydride such as methanesulfonyl anhydride. The reaction can be carried out in an inert solvent such as THF, toluene, DMF or pyridine with or without base such as triethylamine, DBU or pyridine. The reaction temperature can be between −30° C. and 150° C. and the reaction time is usually from 0.5 to 240 hours.

In Scheme 14, R₁ is alkyl, alkenyl, alkynyl, alkylcarbonyl, alkenylcarbonyl, alkynylcarbonyl, alkoxycarbonyl, alkenyloxycarbonyl, alkynyloxycarbonyl, (alkylthio)carbonyl, (alkenylthio)carbonyl, (alkynylthio)carbonyl, (alkyl)thiocarbonyl, (alkenyl)thiocarbonyl, (alkynyl)thiocarbonyl, (alkoxy)thiocarbonyl, (alkenyloxy)thiocarbonyl, (alkynyloxy)thiocarbonyl, (alkylthio)thiocarbonyl, (alkenylthio)thiocarbonyl, (alkynylthio)thiocarbonyl, cycloalkyl, cycloalkenyl, aryl or heterocyclyl. Further, any of these groups may be substituted with one or more of the group(s) selected from the SUBSTITUENT GROUP II.

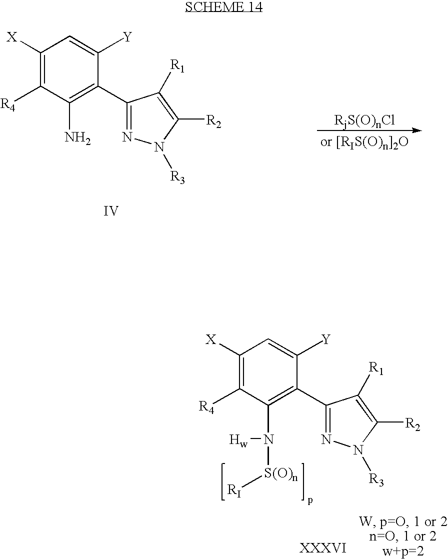

Phenol derivatives represented by formula XXXVII in Scheme 15 can be prepared from compounds of formula XIV according to the literature procedure (e.g. Org. Synth., III, 453). The compounds represented by formula XXXVIII can be prepared from compounds of formula XXXVII by a coupling reaction with formula Rₖ-L in the presence of base such as triethylamine or sodium hydride. The reaction can be carried out at a temperature between −10° C. and 200° C. for 0.5 to 48 hours.

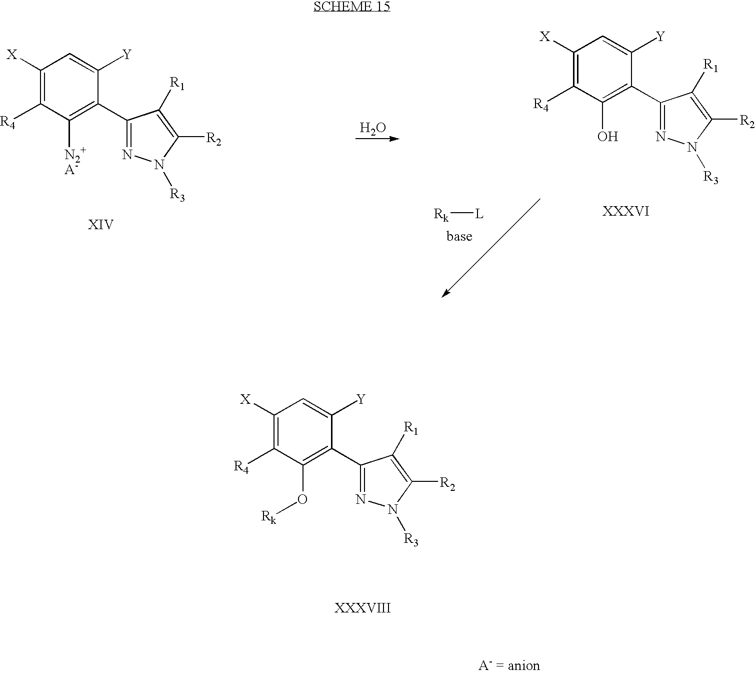

The compounds represented by formula XXXIX in Scheme 16 can be prepared from compounds of formula XIV according to the literature procedure (e.g. J. Org. Chem. 1977, 42, 2426-2431). The compounds represented by formula XXXX can be prepared from compounds of formula XXXIX by a coupling reaction with organometallic compounds such as diethylzinc, phenylboronic acid or tetramethyltin, alkenes such as ethyl acrylate and alkynes such as phenylacetylene. The reaction can be carried out in the presence of metal catalyst such as tetrakis(triphenylphosphine)palladium with or without co-catalyst such as copper(I) iodide in an inert solvent such as diethyl ether, THF, DMF, triethylamine, 1,2-dimethoxyethane or toluene. The reaction temperature can be between −20° C. and 250° C. for 0.5 to 120 hours.

In Scheme 16, Rₘ is carboxyl, formyl, alkyl, alkenyl, alkynyl, alkoxycarbonyl, aryl or heterocyclyl. Further, any of these groups may be substituted with one or more of the group(s) selected from the SUBSTITUENT GROUP I.

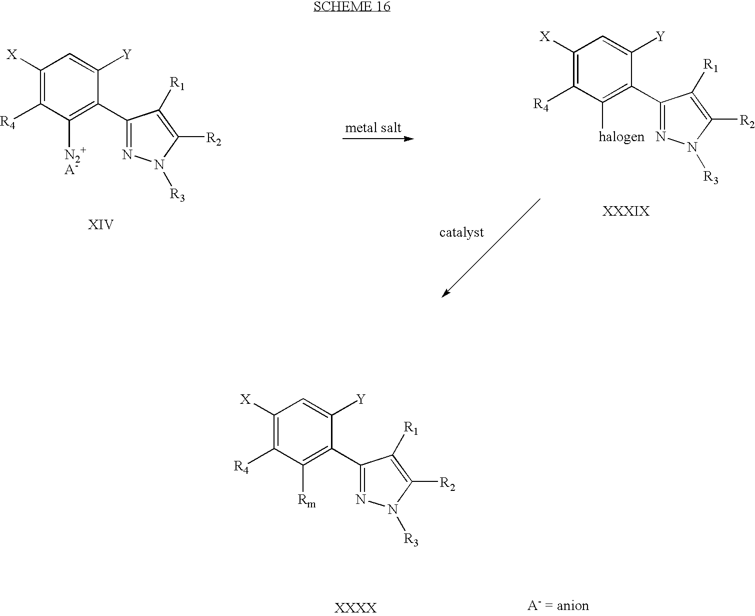

### EXAMPLE 1

### Preparation of 4-chloro-3-(4-chloro-6-fluoro-3-methoxy-2-nitrophenyl)-5-(difluoromethoxy)-1-methyl-1H-pyrazole (Compound No. 2-21)

4-Chloro-3-(4-chloro-2-fluoro-5-methoxyphenyl)-5-(difluoromethoxy)-1-methyl-1H-pyrazole (13 g) was added slowly to a mixed solvent of sulfuric acid (60 ml) and nitric acid (69%, 4.6 g) at 0° C. The resulting mixture was stirred for 2 hours at same temperature and then poured into water. The resulting mixture was partitioned between chloroform (400 ml) and water (500 ml). The organic phase was dried over an hydrous sodium sulfate and concentrated in vacuo. The residual oily product was purified by column chromatography on silica gel eluting with ethyl acetate and hexane (3:7) to give the titled compound (5.5 g).

### EXAMPLE 2

### Preparation of 3-chloro-6-[4-chloro-5-(difluoromethoxy)-1-methyl-1H-pyrazol-3-yl]-5-fluoro-2-methoxybenzenamine (Compound No. 1-90)

4-chloro-3-(4-chloro-6-fluoro-3-methoxy-2-nitrophenyl)-S-(difluoromethoxy)-1-methyl-1H-pyrazole (5.5 g) was dissolved in acetic acid (50 ml). Iron (powdered, 3.9 g) was added and the resulting mixture was stirred vigorously for 12 hours at ambient temperature. The resulting mixture was diluted with sat. brine (300 ml) and extracted with ethyl acetate (400 ml). The organic phase was washed with sat. brine (×3), sat. sodium hydrogen carbonate (×1) and then dried over anhydrous sodium sulfate. The solvent was removed in vacuo to give the titled compound (4.5 g) as a colorless oil.

### EXAMPLE 3

### Preparation of N-[3-chloro-6-[4-chloro-5-difluoromethoxy)-1-methyl-1H-pyrazol-3-yl]-5-fluoro-2-methoxyphenyl]-3-phenyl-(2E)-2-propenamide (Compound No. 1-31)

A mixture of 3-chloro-6-[4-chloro-5-(difluoromethoxy)-1-methyl-1H-pyrazol-3-yl]-5-fluoro-2-methoxy-benzenamine (0.35 g) and cinnamoyl chloride (0.18 g) in 1,4-dioxane (10 ml) was heated at refluxed temperature for 12 hours and then poured into water. The resulting mixture was extracted with ethyl acetate (200 ml) and the organic phase washed with sat. brine (×3) and dried over anhydrous sodium sulfate. The solvent was removed in vacuo to give a brown solid. The crude material was washed with a mixed solvent of diethyl ether and hexane to give the titled compound (0.4 g) as a white solid.

### EXAMPLE 4

### Preparation of 3-chloro-6-[4-chloro-5-(difluoromethoxy)-1-methyl-1H-pyrazol-3-yl]-2-(difluoromethoxy)-5-fluorobenzenamine (Compound No. 1-81)

Chlorodifluoromethane gas was bubbled through a stirred mixture of 2-amino-6-chloro-3-[4-chloro-5-(difluoromethoxy)-1-methyl-1H-pyrazol-3-yl]4-fluorophenol (0-65 g) and potassium carbonate (0.25 g) in DMF (30 ml) at 100° C. for 2 hours and then allowed to cool to ambient temperature. The resulting mixture was partitioned between ethyl acetate and sat. brine. The organic layer was washed with sat. brine (×2) and dried over anhydrous sodium sulfate. The solvent was removed in vacuo and the oily product was subjected to column chromatography on silica gel eluting with ethyl acetate and hexane (2:3) to afford the titled compound (89 mg) as a colorless liquid.

### EXAMPLE 5

### Preparation of [3-chloro-6-[4-chloro-5-(difluoromethoxy)-1-methyl-1H-pyrazol-3-yl]-5-fluoro-2-methoxyphenyl]-formamide (Compound No. 1-4)

3-Chloro-6-[4-chloro-5-(difluoromethoxy)-1-methyl-1H-pyrazol-3-yl]-5-fluoro-2-methoxybenzenamine (3.07 g) was heated to reflux in 98-100% formic acid (150 ml) for 3 hrs. The reaction mixture was poured into water and extracted with ethyl acetate. The organic layer was dried over sodium sulfate and evaporated in vacuo. The residue was recrystalized from n-hexane/dichloromethane (9:1) to afford the titled compound (2.54 g) as colorless crystals.

### EXAMPLE 6

### Preparation of [3-chloro-6-[4-chloro-5-(difluoromethoxy)-1-methyl-1H-pyrazol-3-yl]-5-fluoro-2-methoxyphenyl]2-propynyl-formamide (Compound No. 1-7)

[3-Chloro-6-[4-chloro-5-difluoromethoxy)-1-methyl-1H-pyrazol-3-yl]-5-fluoro-2-methoxyphenyl]-formamide (340 mg) in DMF (4 ml) was added dropwise to a stirred suspension of NaH (39 mg, 60% oil dispersion) in DMF (20 ml) at 0 to 5° C. on an ice water bath. After stirring for 10 minutes at same temperature, a solution of propargyl bromide (111 mg) in DMF (1 ml) was added dropwise to the reaction mixture and kept stirring for 2 hrs. The reaction mixture was poured into water and extracted with ethyl acetate. The organic layer was dried over sodium sulfate and evaporated in vacuo. The residue was subjected to column chromatography on silica gel eluting with ethyl acetate and hexane (2:3) to afford the titled compound (339 mg) as crystals.

### EXAMPLE 7

### Preparation of 3-chloro-6-[4-chloro-5-difluoromethoxy)-1-methyl-1-pyrazol-3-yl]-5-fluoro-2-methoxy-N-(2-propynyl)-benzenamine (Compound No. 1-53)

Conc. hydrochloric acid (4 ml) was added to a solution of [3-chloro-6-[4-chloro-5-(difluoromethoxy)-1-methyl-1H-pyrazol-3-yl]-5-fluoro-2-methoxyphenyl]2-propynyl-formamide (280 mg) in a mixed solvent of methanol/DMF (4 ml/2 ml). The reaction mixture was kept stirring at ambient temperature for 3 days. The resulting mixture was poured into water and extracted with ethyl acetate. The organic layer was dried over sodium sulfate and evaporated in vacuo. The residue was subjected to column chromatography on silica gel eluting with ethyl acetate and hexane (3:7) to afford the titled compound (65 mg) as an oil.

### EXAMPLE 8

### Preparation of 4-Chloro-3-(4-chloro-6-fluoro-2-isocyanato-3-methoxyphenyl-5-(difluoromethoxy)-1-methyl-1H-pyrazole (Compound No. 2-27) as an intermediate

To a solution of triphosgene (9.34 g) in ethyl acetate (91 ml) was added dropwise a solution of 3-chloro-4-[4-chloro-5-(difluoromethoxy)-1-methyl-1H-pyrazol-3-yl]-5-fluoro-2-methoxy-benzenaimine (10 g) and triethylamine (5.67 g) in ethyl acetate (70 ml) at ambient temperature. The resulting solution was heated at refluxed temperature for 2 hours and then allowed to cool to ambient temperature. White precipitate was removed by filtration and the filtrate was concentrated in vacuo to give the titled compound (10.54 g) as a white solid.

### EXAMPLE 9

### Preparation of [3-chloro-6-[4-chloro-5-(difluoromethoxy)-1-methyl-1H-pyrazol-3-yl]-5-fluoro-2-methoxyphenyl]-carbamic acid, 2-pyridinylmethyl ester (Compound No. 1-69)

A mixture of 4-chloro-3-(4-chloro-6-fluoro-2-isocyanato-3-methoxyphenyl)-5-(difluoromethoxy)-1-methyl-1H-pyrazole (0.18 g) and 2-pyridinemethanol (0.5 g) in dry CH₂Cl₂ (5 ml) was stirred for 12 hours at ambient temperature. The reaction mixture was diluted with 5% HCl (150 ml) and extracted with ethyl acetate (50 ml). The organic phase was washed with sat. sodium hydrogen carbonate (×1) and brine (×3), dried over anhydrous sodium sulfate, filtrated and concentrated in vacuo. The residue was purified by column chromatography on silica gel eluting with chloroform and ethanol (10:1) to give the titled compound (0.13 g) as a white solid.

### EXAMPLE 10

### Preparation of N-[3-chloro-6-(4-chloro-1,5-dimethyl-1H-pyrazol-3-yl)-2-(difluoromethoxy)-5-fluorophenyl]-methanesulfonamide (Compound No. 144)

To a mixture of 3-chloro-6-(4-chloro-5-(difluoromethoxy)-1-methyl-1H-pyrazol-3-yl)-2-difluoromethoxy)-5-fluorobenznamine (0.47 g) and methanesulfonyl chloride (1 g) was added pyridine (0.10 g) and the resulting mixture was kept stirring at ambient temperature for 8 days. The reaction mixture was poured into water and extracted with ethyl acetate. The organic layer was dried over sodium sulfate and evaporated in vacuo. Trifluoroacetic anhydride (0.25 g) was added to the residue and evaporated in vacuo. The product was subjected to column chromatography on silica gel eluting with ethyl acetate and hexane (3:7) to afford the titled compound (42 mg) as crystals.

Using the procedures as described in Scheme 1-16 and Examples 1 to 10, the compounds of this invention can be readily prepared. Tables 1 and 2 list structure for few representative compounds of this invention.

The following abbreviations are used in the Tables below.

Me: methyl, Et: ethyl, Pr: propyl, iPr: isopropyl, Bu: butyl, iBu: isobutyl, tbu: tertiary butyl, Ph: phenyl, Ac: acetyl, Bn: benzyl, Bz: benzoyl, Ms: methanesulfonyl, Ts: p-toluenesulfonyl;

TABLE 1

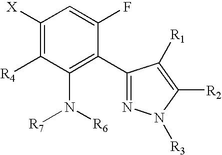

| Compd. No. | X | R₁ | R₂ | R₃ | R₄ | R₇ | R₈ |
|---|---|---|---|---|---|---|---|
| 1-1 | Cl | Cl | OCHF₂ | Me | OMe | H | Ac |
| 1-2 | Cl | Cl | OCHF₂ | Me | OMe | Ac | Ac |
| 1-3 | Cl | Cl | OCHF₂ | Me | OMe | H | iPr—C(O)— |
| 1-4 | Cl | Cl | OCHF₂ | Me | OMe | H | CHO |
| 1-5 | Cl | Cl | OCHF₂ | Me | OMe | H | Bz |
| 1-6 | Cl | Cl | OCHF₂ | Me | OMe | Me | CHO |
| 1-7 | Cl | Cl | OCHF₂ | Me | OMe | Propargyl | CHO |
| 1-8 | Cl | Cl | OCHF₂ | Me | OMe | iPr | CHO |
| 1-9 | Cl | Cl | OCHF₂ | Me | OMe | H | Me₂C═CHC(O)— |
| 1-10 | Cl | Cl | OCHF₂ | Me | OMe | Cyclopentyl | CHO |
| 1-11 | Cl | Cl | OCHF₂ | Me | OMe | Me₂C═CHC(O)— | Me₂C═CHC(O)— |
| 1-12 | Cl | Cl | OCHF₂ | Me | OMe | Ph—C(O)CH₂— | CHO |
| 1-13 | Cl | Cl | OCHF₂ | Me | OMe | 4-ClPhC(O)CH₂— | CHO |
| 1-14 | Cl | Cl | OCHF₂ | Me | OMe | Me—C(O)CH₂— | CHO |
| 1-15 | Cl | Cl | OCHF₂ | Me | OMe | H | PhO—CH₂C(O)— |
| 1-16 | Cl | Cl | OCHF₂ | Me | OMe | H | MeO—CH₂C(O)— |
| 1-17 | Cl | Cl | OCHF₂ | Me | OMe | H | EtO—CH₂C(O)— |
| 1-18 | Cl | Cl | OCHF₂ | Me | OMe | Ph—(CH₂)₂C(O)— | Ph(CH₂)₂C(O)— |
| 1-19 | Cl | Cl | OCHF₂ | Me | OMe | EtO—C(O)CH₂— | CHO |
| 1-20 | Cl | Cl | OCHF₂ | Me | OMe | MeO—C(O)CH₂— | CHO |
| 1-21 | Cl | Cl | OCHF₂ | Me | OMe | H | Ph(CH₂)₂C(O)— |
| 1-22 | Cl | Cl | OCHF₂ | Me | OMe | H | 2-F-benzoyl |
| 1-23 | Cl | Cl | OCHF₂ | Me | OMe | H | 2-Cl-benzoyl |
| 1-24 | Cl | Cl | OCHF₂ | Me | OMe | H | 2-Me-benzoyl |
| 1-25 | Cl | Cl | OCHF₂ | Me | OMe | H | 2-CF₃-benzoyl |
| 1-26 | Cl | Cl | OCHF₂ | Me | OMe | H | 3-Cl-benzoyl |
| 1-27 | CI | Cl | OCHF₂ | Me | OMe | H | 3-Br-benzoyl |
| 1-28 | Cl | Cl | OCHF₂ | Me | OMe | H | 3-MeO-benzoyl |
| 1-29 | Cl | Cl | OCHF₂ | Me | OMe | H | 4-MeO-benzoyl |
| 1-30 | Cl | Cl | OCHF₂ | Me | OMe | H | 2,4-F₂-benzoyl |
| 1-31 | Cl | Cl | OCHF₂ | Me | OMe | H | Cinnamoyl |
| 1-32 | Cl | Cl | OCHF₂ | Me | OMe | H | 4-CN-benzoyl |
| 1-33 | Cl | Cl | OCHF₂ | Me | OMe | H | 2-PhO-propionyl |
| 1-34 | Cl | Cl | OCHF₂ | Me | OMe | H | 3-PhO-propionyl |
| 1-35 | Cl | Cl | OCHF₂ | Me | OMe | H | 4-Cl—PhO-acetyl |
| 1-36 | Cl | Cl | OCHF₂ | Me | OMe | H | 4-CN—PhO-acetyl |
| 1-37 | Cl | Cl | OCHF₂ | Me | OMe | H | 3-(o-Tolyl)propionyl |
| 1-38 | Cl | Cl | OCHF₂ | Me | OMe | H | PhOCMe₂C(O)— |
| 1-39 | Cl | Cl | OCHF₂ | Me | OMe | H | 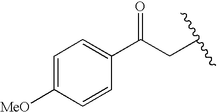 |
| 1-40 | Cl | Cl | OCHF₂ | Me | OMe | H | 3-MeO-propionyl |
| 1-41 | Cl | Cl | OCHF₂ | Me | OMe | H | 2-Ph-propionyl |
| 1-42 | CI | Cl | OCHF₂ | Me | OMe | EtO—C(O)CH(Me)— | CHO |
| 1-43 | Cl | Cl | OCHF₂ | Me | OMe | PhO(CH₂)₂— | CHO |
| 1-44 | Cl | Cl | OCHF₂ | Me | OMe | H | AcOCMe₂C(O)— |
| 1-45 | Cl | Cl | OCHF₂ | Me | OMe | H | BnO-acetyl |
| 1-46 | CN | Br | OCHF₂ | Me | OMe | H | Ac |
| 1-47 | Cl | Cl | OCH₂CF₃ | Et | OMe | Ac | Ac |
| 1-48 | Cl | CN | OCHF₂ | Me | OMe | H | Bz |
| 1-49 | OCF₃ | Cl | OCHF₂ | Me | OMe | H | CHO |
| 1-50 | Cl | Cl | OCHF₂ | Me | OMe | H | 3-MePh(CH₂)₂— |
| 1-51 | Cl | Cl | OCHF₂ | Me | OMe | H | Ph(CH₂)₃C(O)— |
| 1-52 | Cl | Cl | OCHF₂ | Me | OMe | Cl(CH₂)₂OC(O)— | Cl(CH₂)₂OC(O)— |
| 1-53 | Cl | Cl | OCHF₂ | Me | OMe | H | Propargyl |
| 1-54 | Cl | Cl | OCHF₂ | Me | OMe | MeO(CH₂)₂OC(O)— | MeO(CH₂)₂OC(O)— |
| 1-55 | Cl | Cl | OCHF₂ | Me | OMe | Cl(CH₂)OC(O)— | Cl(CH₂)OC(O)— |
| 1-56 | Cl | Cl | OCHF₂ | Me | OMe | H | 4-MeOBnOC(O)— |
| 1-57 | Cl | Cl | OCHF₂ | Me | OMe | H | 4-MeOPhOC(O)— |
| 1-58 | Cl | Cl | OCHF₂ | Me | OMe | H | Me |
| 1-59 | Cl | Cl | OCHF₂ | Me | OMe | H | iPr |
| 1-60 | Cl | Cl | OCHF₂ | Me | OMe | H | Cyclopentyl |
| 1-61 | Cl | Cl | OCHF₂ | Me | OMe | H | MeO(CH₂)₂OC(O)— |
| 1-62 | Cl | Cl | OCHF₂ | Me | OMe | H | Methoxycarbonyl |
| 1-63 | Cl | Cl | OCHF₂ | Me | OMe | H | 2-Cl—PhCH2OC(O)— |
| 1-64 | Cl | Cl | OCHF₂ | Me | OMe | H | iBuOC(O)— |
| 1-65 | Cl | Cl | OCHF₂ | Me | OMe | 4-MeOPhOC(O)— | 4-MeOPhOC(O)— |
| 1-66 | Cl | Cl | OCHF₂ | Me | OMe | H | Me₂N(CH₂)₂OC(O)— |
| 1-67 | Cl | Cl | OCHF₂ | Me | OMe | H | PhOC(O)— |
| 1-68 | Cl | Cl | OCHF₂ | Me | OMe | H | Cl(CH₂)₂OC(O)— |
| 1-69 | Cl | Cl | OCHF₂ | Me | OMe | H | 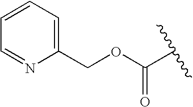 |
| 1-70 | Cl | Cl | OCHF₂ | Me | OMe | H | 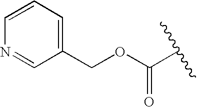 |
| 1-71 | Cl | Cl | OCHF₂ | Me | OMe | H | Bn—O—C(O)— |
| 1-72 | Cl | Cl | OCHF₂ | Me | OMe | H | Pr—O—C(O)— |
| 1-73 | Cl | Cl | OCHF₂ | Me | OMe | H | 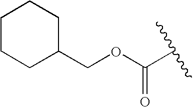 |
| 1-74 | Cl | Cl | OCHF₂ | Me | OMe | H | Propargyl-OC(O)— |
| 1-75 | Cl | Cl | OCHF₂ | Me | OMe | H | iPr—O—C(O)— |
| 1-76 | Cl | Cl | OCHF₂ | Me | OMe | H | EtO—C(O)CH(Me)— |
| 1-77 | Cl | Cl | OCHF₂ | Me | OMe | H | PhO(CH₂)₂— |
| 1-78 | Cl | Cl | OCHF₂ | Me | OMe | H | Me₂NC(O)— |
| 1-79 | Cl | Cl | OCHF₂ | Me | OMe | H | MePhNC(O)— |
| 1-80 | Cl | Cl | OCHF₂ | Me | OMe | H | BnMeNC(O)— |
| 1-81 | Cl | Cl | OCHF₂ | Me | OCHF₂ | H | H |
| 1-82 | Cl | Cl | OCHF₂ | Me | OCHF₂ | H | CHO |
| 1-83 | Cl | Cl | OCHF₂ | Me | OCHF₂ | H | Trifluoroacetyl |
| 1-84 | Cl | Cl | OCHF₂ | Me | OCHF₂ | H | Ms |
| 1-85 | Cl | Cl | OCHF₂ | Me | OCHF₂ | Propargyl | CHO |
| 1-86 | Cl | Cl | OCHF₂ | Me | OCHF₂ | Bn | CHO |
| 1-87 | Cl | Cl | OCHF₂ | Me | OCHF₂ | Propargyl | H |
| 1-88 | Cl | Cl | OCHF₂ | Me | OCHF₂ | H | Bn |
| 1-89 | CN | Cl | OCHF₂ | Me | OMe | H | H |
| 1-90 | Cl | Cl | OCHF₂ | Me | OMe | H | H |
| 1-91 | CN | Cl | OCHF₂ | Me | OMe | H | Ac |
| 1-92 | CN | Cl | OCHF₂ | Me | OMe | Ac | Ac |
| 1-93 | CN | Cl | OCHF₂ | Me | OMe | H | iBu—C(O)— |
| 1-94 | CN | Cl | OCHF₂ | Me | OMe | H | CHO |
| 1-95 | CN | Cl | OCHF₂ | Me | OMe | H | Bz |
| 1-96 | CN | Cl | OCHF₂ | Me | OMe | Me | CHO |
| 1-97 | CN | Cl | OCHF₂ | Me | OMe | Propargyl | CHO |
| 1-98 | CN | Cl | OCHF₂ | Me | OMe | iPr | CHO |
| 1-99 | CN | Cl | OCHF₂ | Me | OMe | H | Me₂C═CHC(O)— |
| 1-100 | CN | Cl | OCHF₂ | Me | OMe | Cyclopentyl | CHO |
| 1-101 | CN | Cl | OCHF₂ | Me | OMe | Me₂C═CHC(O)— | Me₂C═CHC(O)— |
| 1-102 | CN | Cl | OCHF₂ | Me | OMe | PhC(O)CH₂— | CHO |
| 1-103 | CN | Cl | OCHF₂ | Me | OMe | 4-ClPhC(O)CH₂— | CHO |
| 1-104 | CN | Cl | OCHF₂ | Me | OMe | MeC(O)CH₂— | CHO |
| 1-105 | CN | Cl | OCHF₂ | Me | OMe | H | PhOCH₂C(O)— |
| 1-106 | CN | Cl | OCHF₂ | Me | OMe | H | MeOCH₂C(O)— |
| 1-107 | CN | Cl | OCHF₂ | Me | OMe | H | EtOCH₂C(O)— |
| 1-108 | CN | Cl | OCHF₂ | Me | OMe | Ph(CH₂)₂C(O)— | Ph(CH₂)₂C(O)— |
| 1-109 | CN | Cl | OCHF₂ | Me | OMe | EtOC(O)CH₂— | CHO |
| 1-110 | CN | Cl | OCHF₂ | Me | OMe | MeOC(O)CH₂— | CHO |
| 1-111 | CN | Cl | OCHF₂ | Me | OMe | H | Ph(CH₂)₂C(O)— |
| 1-112 | CN | Cl | OCHF₂ | Me | OMe | H | 2-F-benzoyl |
| 1-113 | CN | Cl | OCHF₂ | Me | OMe | H | 2-Cl-benzoyl |
| 1-114 | CN | Cl | OCHF₂ | Me | OMe | H | 2-Me-benzoyl |
| 1-115 | CN | Cl | OCHF₂ | Me | OMe | H | 2-CF₃-benzoyl |
| 1-116 | CN | Cl | OCHF₂ | Me | OMe | H | 3-Cl-benzoyl |
| 1-117 | CN | Cl | OCHF₂ | Me | OMe | H | 3-Br-benzoyl |
| 1-118 | CN | Cl | OCHF₂ | Me | OMe | H | 3-MeO-benzoyl |
| 1-119 | CN | Cl | OCHF₂ | Me | OMe | H | 4-MeO-benzoyl |
| 1-120 | CN | Cl | OCHF₂ | Me | OMe | H | 2,4-F₂-benzoyl |
| 1-121 | CN | Cl | OCHF₂ | Me | OMe | H | Cinnamoyl |
| 1-122 | CN | Cl | OCHF₂ | Me | OMe | H | 4-CN-benzoyl |
| 1-123 | CN | Cl | OCHF₂ | Me | OMe | H | 2-PhO-propionyl |
| 1-124 | CN | Cl | OCHF₂ | Me | OMe | H | 3-PhO-propionyl |
| 1-125 | CN | Cl | OCHF₂ | Me | OMe | H | 4-Cl—PhO-acetyl |
| 1-126 | CN | Cl | OCHF₂ | Me | OMe | H | 4-CN—PhO-acetyl |
| 1-127 | CN | Cl | OCHF₂ | Me | OMe | H | 2-MePh(CH₂)₂C(O)— |
| 1-128 | CN | Cl | OCHF₂ | Me | OMe | H | PhOCMe₂C(O)— |
| 1-129 | CN | Cl | OCHF₂ | Me | OMe | H | 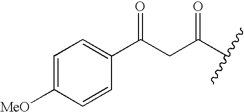 |
| 1-130 | CN | Cl | OCHF₂ | Me | OMe | H | MeO(CH₂)₂C(O)— |
| 1-131 | CN | Cl | OCHF₂ | Me | OMe | H | 2-Ph-propionyl |
| 1-132 | CN | Cl | OCHF₂ | Me | OMe | EtO—C(O)CHMe— | CHO |
| 1-133 | CN | Cl | OCHF₂ | Me | OMe | PhO(CH₂)₂— | CHO |
| 1-134 | CN | Cl | OCHF₂ | Me | OMe | H | AcOCMe₂C(O)— |
| 1-135 | CN | Cl | OCHF₂ | Me | OMe | H | PhO(CH₂)₂C(O)— |
| 1-136 | CN | Cl | OCHF₂ | Me | OMe | H | 3-MePh(CH₂)₂C(O)— |
| 1-137 | CN | Cl | OCHF₂ | Me | OMe | H | BnOCH₂C(O)— |
| 1-138 | CN | Cl | OCHF₂ | Me | OMe | Cl(CH₂)₂C(O)— | Cl(CH₂)₂C(O)— |
| 1-139 | CN | Cl | OCHF₂ | Me | OMe | H | Propargyl |
| 1-140 | CN | Cl | OCHF₂ | Me | OMe | MeO(CH₂)₂OC(O)— | MeO(CH₂)₂OC(O)— |
| 1-141 | CN | Cl | OCHF₂ | Me | OMe | ClCH₂OC(O)— | ClCH₂OC(O)— |
| 1-142 | CN | Cl | OCHF₂ | Me | OMe | H | 4-MeOBnOC(O)— |
| 1-143 | CN | Cl | OCHF₂ | Me | OMe | H | 4-MeOPhOC(O)— |
| 1-144 | CN | Cl | OCHF₂ | Me | OMe | H | Me |
| 1-145 | CN | Cl | OCHF₂ | Me | OMe | H | iPr |
| 1-146 | CN | Cl | OCHF₂ | Me | OMe | H | Cyclopentyl |
| 1-147 | CN | Cl | OCHF₂ | Me | OMe | H | MeO(CH₂)₂OC(O)— |
| 1-148 | CN | Cl | OCHF₂ | Me | OMe | H | MeOC(O)— |
| 1-149 | CN | Cl | OCHF₂ | Me | OMe | H | 2-Cl—PhCH₂OC(O)— |
| 1-150 | CN | Cl | OCHF₂ | Me | OMe | H | iBu—O—C(O)— |
| 1-151 | CN | Cl | OCHF₂ | Me | OMe | 4-MeOPhOC(O)— | 4-MeOPhOC(O)— |
| 1-152 | CN | Cl | OCHF₂ | Me | OMe | H | Me₂N(CH₂)₂OC(O)— |
| 1-153 | CN | Cl | OCHF₂ | Me | OMe | H | PhO—C(O)— |
| 1-154 | CN | Cl | OCHF₂ | Me | OMe | H | Cl(CH₂)₂OC(O)— |
| 1-155 | CN | Cl | OCHF₂ | Me | OMe | H | 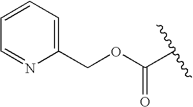 |
| 1-156 | CN | Cl | OCHF₂ | Me | OMe | H | 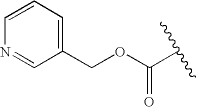 |
| 1-157 | CN | Cl | OCHF₂ | Me | OMe | H | Bn—O—C(O)— |
| 1-158 | CN | Cl | OCHF₂ | Me | OMe | H | PrO—C(O)— |
| 1-159 | CN | Cl | OCHF₂ | Me | OMe | H | 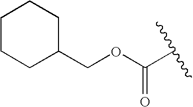 |
| 1-160 | CN | Cl | OCHF₂ | Me | OMe | H | Propargyl-OC(O)— |
| 1-161 | CN | Cl | OCHF₂ | Me | OMe | H | iPr—O—C(O)— |
| 1-162 | CN | Cl | OCHF₂ | Me | OMe | H | EtO—C(O)CHMe— |
| 1-163 | CN | Cl | OCHF₂ | Me | OMe | H | PhO(CH₂)₂— |
| 1-164 | CN | Cl | OCHF₂ | Me | OMe | H | Me₂NC(O)— |
| 1-165 | CN | Cl | OCHF₂ | Me | OMe | H | MePhNC(O)— |
| 1-166 | Cl | Cl | OCHF₂ | Me | Me | H | H |
| 1-167 | Cl | Cl | OCHF₂ | Me | Me | H | Ac |
| 1-168 | Cl | Cl | OCHF₂ | Me | Me | Ac | Ac |
| 1-169 | Cl | Cl | OCHF₂ | Me | Me | H | iPr—C(O)— |
| 1-170 | Cl | Cl | OCHF₂ | Me | Me | H | CHO |
| 1-171 | Cl | Cl | OCHF₂ | Me | Me | H | Bz |
| 1-172 | Cl | Cl | OCHF₂ | Me | Me | Me | CHO |
| 1-173 | Cl | Cl | OCHF₂ | Me | Me | Propargyl | CHO |
| 1-174 | Cl | Cl | OCHF₂ | Me | Me | iPr | CHO |
| 1-175 | Cl | Cl | OCHF₂ | Me | Me | H | Me₂C═CHC(O)— |
| 1-176 | Cl | Cl | OCHF₂ | Me | Me | Cyclopentyl | CHO |
| 1-177 | Cl | Cl | OCHF₂ | Me | Me | Ph | CHO |
| 1-178 | Cl | Cl | OCHF₂ | Me | Me | 4-ClPhC(O)CH₂— | CHO |
| 1-179 | Cl | Cl | OCHF₂ | Me | Me | MeC(O)CH₂— | CHO |
| 1-180 | Cl | Cl | OCHF₂ | Me | Me | H | PhO-CH₂C(O)— |
| 1-181 | Cl | Cl | OCHF₂ | Me | Me | H | MeO—CH₂C(O)— |
| 1-182 | Cl | Cl | OCHF₂ | Me | Me | Ph(CH₂)₂C(O)— | Ph—(CH₂)₂C(O)— |
| 1-183 | Cl | Cl | OCHF₂ | Me | Me | EtO—C(O)CH₂— | CHO |
| 1-184 | Cl | Cl | OCHF₂ | Me | Me | MeOC(O)CH₂— | CHO |
| 1-185 | Cl | Cl | OCHF₂ | Me | Me | H | Ph(CH₂)₂C(O)— |
| 1-186 | Cl | Cl | OCHF₂ | Me | Me | H | 2-F-benzoyl |
| 1-187 | Cl | Cl | OCHF₂ | Me | Me | H | 2-Cl-benzoyl |
| 1-188 | Cl | Cl | OCHF₂ | Me | Me | H | 2-Me-benzoyl |
| 1-189 | Cl | Cl | OCHF₂ | Me | Me | H | 2-CF₃-benzyl |
| 1-190 | Cl | Cl | OCHF₂ | Me | Me | H | 3-Cl-benzoyl |
| 1-191 | Cl | Cl | OCHF₂ | Me | Me | H | 3-Br-benzoyl |
| 1-192 | Cl | Cl | OCHF₂ | Me | Me | H | 3-MeO-benzoyl |
| 1-193 | Cl | Cl | OCHF₂ | Me | Me | H | 4-MeO-benzoyl |
| 1-194 | Cl | Cl | OCHF₂ | Me | Me | H | 2,4-F₂-benzoyl |
| 1-195 | Cl | Cl | OCHF₂ | Me | Me | H | Cinnamoyl |
| 1-196 | Cl | Cl | OCHF₂ | Me | Me | H | 4-CN-benzoyl |
| 1-197 | Cl | Cl | OCHF₂ | Me | Me | H | 2-PhO-propionyl |
| 1-198 | Cl | Cl | OCHF₂ | Me | Me | H | PhO(CH₂)₂C(O)— |
| 1-199 | Cl | Cl | OCHF₂ | Me | Me | H | 4-Cl—PhOCH₂C(O)— |
| 1-200 | Cl | Cl | OCHF₂ | Me | Me | H | 4-CN—PhOCH₂C(O)— |
| 1-201 | Cl | Cl | OCHF₂ | Me | Me | H | 2-MePh(CH₂)₂C(O)— |
| 1-202 | Cl | Cl | OCHF₂ | Me | Me | H | PhOCMe₂C(O)— |
| 1-203 | Cl | Cl | OCHF₂ | Me | Me | H | 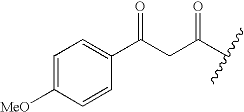 |
| 1-204 | Cl | Cl | OCHF₂ | Me | Me | H | MeO(CH₂)₂C(O)— |
| 1-205 | Cl | Cl | OCHF₂ | Me | Me | H | Ph—CHMeC(O)— |
| 1-206 | Cl | Cl | OCHF₂ | Me | Me | EtO—C(O)CHMe— | CHO |
| 1-207 | Cl | Cl | OCHF₂ | Me | Me | PhO(CH₂)₂— | CHO |
| 1-208 | Cl | Cl | OCHF₂ | Me | Me | H | AcOCMe₂C(O)— |
| 1-209 | Cl | Cl | OCHF₂ | Me | Me | H | PhO—(CH₂)₂C(O)— |
| 1-210 | Cl | Cl | OCHF₂ | Me | Me | H | 3-MePh(CH₂)₂C(O)— |
| 1-211 | Cl | Cl | OCHF₂ | Me | Me | H | BnOCH₂C(O)— |
| 1-212 | Cl | Cl | OCHF₂ | Me | Me | Cl(CH₂)₂OC(O)— | Cl(CH₂)₂OC(O)— |
| 1-213 | Cl | Cl | OCHF₂ | Me | Me | H | Propargyl |
| 1-214 | Cl | Cl | OCHF₂ | Me | Me | MeO(CH₂)₂OC(O)— | MeO(CH₂)₂OC(O)— |
| 1-215 | Cl | Cl | OCHF₂ | Me | Me | ClCH₂OC(O)— | ClCH₂OC(O)— |
| 1-216 | Cl | Cl | OCHF₂ | Me | Me | H | 4-MeOBnOC(O)— |
| 1-217 | Cl | Cl | OCHF₂ | Me | Me | H | 4-MeOPhOC(O)— |
| 1-218 | Cl | Cl | OCHF₂ | Me | Me | H | Me |
| 1-219 | Cl | Cl | OCHF₂ | Me | Me | H | iPr |
| 1-220 | Cl | Cl | OCHF₂ | Me | Me | H | Cyclopentyl |
| 1-221 | Cl | Cl | OCHF₂ | Me | Me | H | MeO(CH₂)₂OC(O)— |
| 1-222 | Cl | Cl | OCHF₂ | Me | Me | H | MeOC(O)— |
| 1-223 | Cl | Cl | OCHF₂ | Me | Me | H | 2-ClPhCH₂OC(O)— |
| 1-224 | Cl | Cl | OCHF₂ | Me | Me | H | iBu—O—C(O)— |
| 1-225 | Cl | Cl | OCHF₂ | Me | Me | 4-MeOPhOC(O)— | 4-MeOPhOC(O)— |
| 1-226 | Cl | Cl | OCHF₂ | Me | Me | H | Me₂N(CH₂)₂OC(O)— |
| 1-227 | Cl | Cl | OCHF₂ | Me | Me | H | PhO—C(O)— |
| 1-228 | Cl | Cl | OCHF₂ | Me | Me | H | Cl(CH₂)₂OC(O)— |
| 1-229 | Cl | Cl | OCHF₂ | Me | Me | H | 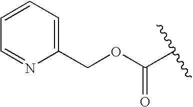 |
| 1-230 | Cl | Cl | OCHF₂ | Me | Me | H | 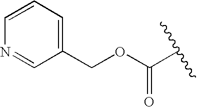 |
| 1-231 | Cl | Cl | OCHF₂ | Me | Me | H | BnO—C(O)— |
| 1-232 | Cl | Cl | OCHF₂ | Me | Me | H | PrO—C(O)— |
| 1-233 | Cl | Cl | OCHF₂ | Me | Me | H | 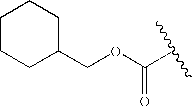 |
| 1-234 | Cl | Cl | OCHF₂ | Me | Me | H | Propargyl-OC(O)— |
| 1-235 | Cl | Cl | OCHF₂ | Me | Me | H | iPr—O—C(O)— |
| 1-236 | Cl | Cl | OCHF₂ | Me | Me | H | EtO—C(O)CHMe— |
| 1-237 | Cl | Cl | OCHF₂ | Me | Me | H | PhO(CH₂)₂— |
| 1-238 | Cl | Cl | OCHF₂ | Me | Me | H | Me₂NC(O)— |
| 1-239 | Cl | Cl | OCHF₂ | Me | Me | H | MePhNC(O)— |
| 1-240 | Cl | Cl | OCHF₂ | Me | OMe | NH₂ | H |
| 1-241 | CN | Cl | OCHF₂ | Me | OMe | NH₂ | H |
| 1-242 | Cl | Cl | OCHF₂ | Me | Me | NH₂ | Me₂C═N— |
| 1-243 | Cl | Cl | OCHF₂ | Me | OMe | H | 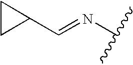 |
| 1-244 | Cl | Cl | OCHF₂ | Me | OCHF₂ | Ms | Ms |
| 1-245 | Cl | Cl | OCHF₂ | Me | OMe | H | PhCH═N— |
| 1-246 | Cl | Cl | OCHF₂ | Me | OMe | H | AcNH— |
| 1-247 | Cl | Cl | OCHF₂ | Me | OMe | H | EtO—C(O)NH— |
| 1-248 | Cl | Cl | OCHF₂ | Me | OMe | H | Ac₂N— |
| 1-249 | Cl | Cl | OCHF₂ | Me | OMe | H | [EtOC(O)]₂N— |
| 1-250 | Cl | Cl | OCHF₂ | Me | OMe | Me | Me |
| 1-251 | Cl | Cl | OCHF₂ | Me | OMe | H | PhCH═C(Me)C(O)— |
| 1-252 | Cl | Cl | OCHF₂ | Me | OMe | H | 2,6-Cl₂-cinnamoyl |
| 1-253 | Cl | Cl | OCHF₂ | Me | OMe | H | 2-Me-cinnamoyl |
| 1-254 | Cl | Cl | OCHF₂ | Me | OMe | H | 3-Me-cinnamoyl |
| 1-255 | Cl | Cl | OCHF₂ | Me | OMe | H | 4-Me-cinnamoyl |
| 1-256 | Cl | Cl | OCHF₂ | Me | OMe | H | 2-F-cinnamoyl |
| 1-257 | Cl | Cl | OCHF₂ | Me | OMe | H | 3-F-cinnamoyl |
| 1-258 | Cl | Cl | OCHF₂ | Me | OMe | H | 4-F-cinnamoyl |
| 1-259 | Cl | Cl | OCHF₂ | Me | OMe | H | 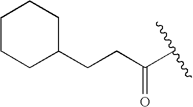 |
| 1-260 | Cl | Cl | OCHF₂ | Me | OMe | H | 3-Me-benzoyl |
| 1-261 | Cl | Cl | OCHF₂ | Me | OMe | H | 4-Me-benzoyl |
| 1-262 | Cl | Cl | OCHF₂ | Me | OMe | H | 3-CF₃-benzoyl |
| 1-263 | Cl | Cl | OCHF₂ | Me | OMe | H | 4-F-benzoyl |
| 1-264 | Cl | Cl | OCHF₂ | Me | OMe | H | Cyclopropanecarbonyl |
| 1-265 | Cl | Cl | OCHF₂ | Me | OMe | H | (CH₃)₃CCH₂C(O)— |
| 1-266 | Cl | Cl | OCHF₂ | Me | OMe | H | 3-F—Ph(CH₂)₂C(O)— |
| 1-267 | Cl | Cl | OCHF₂ | Me | OMe | H | 4-F—Ph(CH₂)₂C(O)— |
| 1-268 | Cl | Cl | OCHF₂ | Me | OMe | H | PhCH₂CHMeC(O)— |
| 1-269 | Cl | Cl | OCHF₂ | Me | OMe | H | 2-F—Ph(CH₂)₂C(O)— |
| 1-270 | Cl | Cl | OCHF₂ | Me | 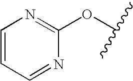 | H | H |
| 1-271 | Cl | Cl | OCHF₂ | Me | OMe | H | 2-Naphthoyl |
| 1-272 | Cl | Cl | OCHF₂ | Me | OMe | Me | Ac |
| 1-273 | Cl | Cl | OCHF₂ | Me | OMe | H | EtO—C(O)— |
| 1-274 | Cl | Cl | OCHF₂ | Me | OMe | H | 2-Br-benzoyl |
| 1-275 | Cl | Cl | OCHF₂ | Me | OMe | H | 2-MeO-benzoyl |
| 1-276 | Cl | Cl | OCHF₂ | Me | OMe | H | 2-CF₃-benzoyl |
| 1-277 | Cl | Cl | OCHF₂ | Me | OMe | H | 3-Br-benzoyl |
| 1-278 | Cl | Cl | OCHF₂ | Me | OMe | H | 4-Ethyl-benzoyl |
| 1-279 | Cl | Cl | OCHF₂ | Me | OMe | H | 4-Me₂N-benzoyl |
| 1-280 | Cl | Cl | OCHF₂ | Me | OMe | H | 4-CF₃-benzoyl |
| 1-281 | Cl | Cl | OCHF₂ | Me | OMe | H | 2,4-(MeO)₂-benzoyl |
| 1-282 | Cl | Cl | OCHF₂ | Me | OMe | H | 2,4,6-Cl₃-benzoyl |
| 1-283 | Cl | Cl | OCHF₂ | Me | OMe | H | 3-Pyridinecarbonyl |
| 1-284 | Cl | Cl | OCHF₂ | Me | OMe | H | 2-Pyridinecarbonyl |
| 1-285 | Cl | Cl | OCHF₂ | Me | OMe | H | 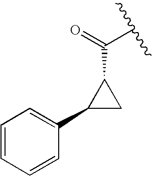 |
| 1-286 | Cl | Cl | OCHF₂ | Me | OMe | H | 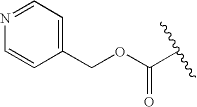 |
| 1-287 | Cl | Cl | OCHF₂ | Me | OMe | H | 3-NO₂PhCH₂OC(O)— |
| 1-288 | Cl | Cl | OCHF₂ | Me | OMe | —C(O)OCH₂CH₂— | |
| 1-289 | Cl | Cl | OCHF₂ | Me | OMe | H | Me₂C═NOC(O)— |
| 1-290 | Cl | Cl | OCHF₂ | Me | OMe | H | 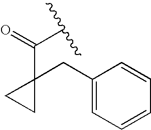 |
| 1-291 | Cl | Cl | OCHF₂ | Me | Et | H | H |
| 1-292 | Cl | Cl | OCHF₂ | Me | OMe | Me | Propargyl |
| 1-293 | Cl | Cl | OCHF₂ | Me | OMe | Ac | Propargyl |
| 1-294 | Cl | Cl | OCHF₂ | Me | OMe | H | MeOC(O)CH₂— |
| 1-295 | Cl | Cl | OCHF₂ | Me | OMe | H | 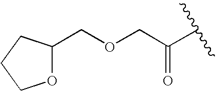 |
| 1-296 | Cl | Cl | OCHF₂ | Me | OMe | H | 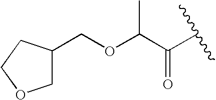 |
| 1-297 | Cl | Cl | OCHF₂ | Me | OMe | H | MeO—N(Me)C(O)— |
| 1-298 | Cl | Cl | OCHF₂ | Me | OMe | H | MeOCMe₂C(O)— |
| 1-299 | Cl | Cl | OCHF₂ | Me | OMe | H | 3-Cl—PhOCH₂C(O)— |
| 1-300 | Cl | Cl | OCHF₂ | Me | OMe | H | 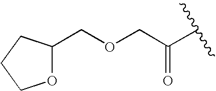 |
| 1-301 | Cl | Cl | OCHF₂ | Me | OMe | H | 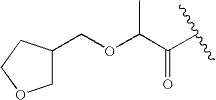 |
| 1-302 | Cl | Cl | OCHF₂ | Me | OMe | H | 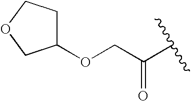 |
| 1-303 | Cl | Cl | OCHF₂ | Me | OMe | H | 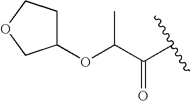 |
| 1-304 | Cl | Cl | OCHF₂ | Me | OMe | Me | Methoxycarbonyl |
| 1-305 | Cl | Cl | OCHF₂ | Me | OMe | Me | 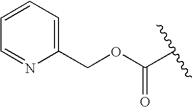 |
| 1-306 | Cl | Cl | OCHF₂ | Me | OMe | Me | 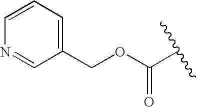 |
| 1-307 | Cl | Cl | OCHF₂ | Me | OMe | Me | 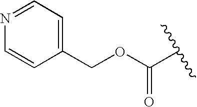 |
| 1-308 | Cl | Cl | OCHF₂ | Me | OMe | H | 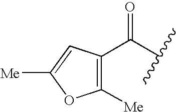 |
| 1-309 | Cl | Cl | OCHF₂ | Me | OMe | H | 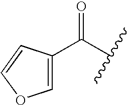 |
| 1-310 | Cl | Cl | OCHF₂ | Me | OMe | H | 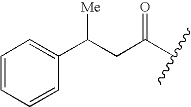 |
| 1-311 | Cl | Cl | OCHF₂ | Me | OMe | H | 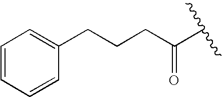 |
| 1-312 | Cl | Cl | OCHF₂ | Me | OMe | H | 2-NO₂PhOC(O)— |

TABLE 2

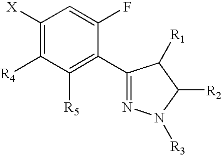

| Compd. | | | | | | |
|---|---|---|---|---|---|---|
| No | X | R₁ | R₂ | R₃ | R₄ | R₅ |
| 2-1 | Cl | Cl | OCHF₂ | Me | OMe | CHO |
| 2-2 | Cl | Cl | OCHF₂ | Me | OMe | CO₂H |
| 2-3 | Cl | Cl | OCHF₂ | Me | OMe | Me₂C═N— |
| 2-4 | Cl | Cl | OCHF₂ | Me | OMe | COCl |
| 2-5 | Cl | Cl | OCHF₂ | Me | OMe | McPhNC(O)— |
| 2-6 | Cl | Cl | OCHF₂ | Me | OMe | Me₂NC(O)— |
| 2-7 | Cl | Cl | OCHF₂ | Me | OMe | MoOC(O)— |
| 2-8 | Cl | Cl | OCHF₂ | Me | OMe | Cl |
| 2-9 | Cl | Cl | OCHF₂ | Me | OMe | Me |
| 2-10 | Cl | Cl | OCHF₂ | Me | OMe | HOCH₂— |
| 2-11 | Cl | Cl | OCHF₂ | Me | OMe | I |
| 2-12 | Cl | Cl | OCHF₂ | Me | OMe | Benzoyl |
| 2-13 | Cl | Cl | OCHF₂ | Me | OMe | EtOC(O)CHClCH₂— |
| 2-14 | Cl | Cl | OCHF₂ | Me | OMe | OH |
| 2-15 | Cl | Cl | OCHF₂ | Me | OMe | MeO |
| 2-16 | Cl | CI | OCHF₂ | Me | OMe | Ac |
| 2-17 | Cl | Cl | OCHF₂ | Me | OMe | McS |
| 2-18 | Cl | Cl | OCHF₂ | Me | OMe | PhS(O)₂— |
| 2-19 | Cl | Cl | OCHF₂ | Me | OMe | NH₂C(O)— |
| 2-20 | Br | Cl | OCHF₂ | Me | OMe | CHO |
| 2-21 | Cl | Cl | OCHF₂ | Me | OMe | NO₂ |
| 2-22 | Cl | Br | OCHF₂ | Me | OMe | CHO |
| 2-23 | Cl | Cl | OCHF₂ | Me | OMe | BnS |
| 2-24 | Cl | Cl | OCHF₂ | Me | OCHF₂ | CHO |
| 2-25 | Cl | CI | OCHF₂ | Me | OCHF₂ | CO₂H |
| 2-26 | Cl | Cl | OCHF₂ | Me | Me | EtOC(O)CHClCH₂— |
| 2-27 | Cl | Cl | OCHF₂ | Me | OMe | NCO |
| 2-28 | Cl | Cl | OCHF₂ | Me | OMe | Me₂C═NOC(O)— |
| 2-29 | CN | Cl | OCHF₂ | Me | OMe | CHO |
| 2-30 | CN | Cl | OCHF₂ | Me | OMe | CO₂H |
| 2-31 | CN | Cl | OCHF₂ | Me | OMe | Me₂C═N— |
| 2-32 | CN | Cl | OCHF₂ | Me | OMe | COCl |
| 2-33 | CN | Cl | OCHF₂ | Me | OMe | MePhNC(O)— |
| 2-34 | CN | Cl | OCHF₂ | Me | OMe | Me₂NC(O)— |
| 2-35 | CN | Cl | OCHF₂ | Me | OMe | MeOC(O)— |
| 2-36 | CN | Cl | OCHF₂ | Me | OMe | Cl |
| 2-37 | CN | Cl | OCHF₂ | Me | OMe | Me |
| 2-38 | CN | Cl | OCHF₂ | Me | OMe | HOCH₂— |
| 2-39 | CN | Cl | OCHF₂ | Me | OMe | I |
| 2-40 | CN | Cl | OCHF₂ | Me | OMe | Benzoyl |
| 2-41 | CN | Cl | OCHF₂ | Me | OMe | EtOC(O)CHClCH₂— |
| 2-42 | CN | Cl | OCHF₂ | Me | OMe | OH |
| 2-43 | CN | Cl | OCHF₂ | Me | OMe | MeO |
| 2-44 | CN | Cl | OCHF₂ | Me | OMe | Ac |
| 2-45 | CN | Cl | OCHF₂ | Me | OMo | MeS |
| 2-46 | CN | Cl | OCHF₂ | Me | OMe | PhS(O)₂— |
| 2-47 | CN | Cl | OCHF₂ | Me | OMe | NH₂C(O)— |
| 2-48 | Cl | CN | OCHF₂ | Me | OMe | Mc |
| 2-49 | Cl | Cl | OCHF₂ | Me | OMe | EtOC(O)CH═CH— |

The Table 3-1 and Table 3-2 lists some of the characterization data for several representative compounds of this invention.

TABLE 3-1

| Compd.No | Melting point (° C.) |
|---|---|
| 1-3 | 109-111 |
| 1-4 | 100-103 |
| 1-16 | 112-114 |
| 1-18 | (amorphous) |
| 1-26 | 155 |
| 1-27 | 142 |
| 1-34 | 90-93 |
| 1-36 | 171-173 |
| 1-38 | 132-134 |
| 1-45 | 81-84 |
| 1-55 | 91-93 |
| 1-57 | 41-44 |
| 1-58 | 75-77 |
| 1-61 | 66-67 |
| 1-62 | 135-138 |
| 1-64 | 90-92 |
| 1-65 | 100-103 |
| 1-67 | 122-125 |
| 1-68 | 105-108 |
| 1-69 | 35-37 |
| 1-70 | 39-40 |
| 1-71 | 88-91 |
| 1-72 | 72-76 |
| 1-73 | 68-70 |
| 1-74 | 102-103 |
| 1-75 | 116-118 |
| 1-82 | 103-105 |
| 1-83 | 127-129 |
| 1-84 | 197-199 |
| 1-85 | 82-85 |
| 1-254 | 142 |
| 1-255 | 161 |
| 1-256 | 185 |
| 1-257 | 165 |
| 1-258 | 188 |
| 1-259 | 138 |
| 1-260 | 131 |
| 1-261 | 124 |
| 1-262 | 117 |
| 1-263 | 165 |
| 1-264 | 143 |
| 1-265 | 148 |
| 1-266 | 139 |
| 1-267 | 116 |
| 1-268 | 137 |
| 1-269 | 120 |
| 1-274 | 141 |
| 1-275 | 114 |
| 1-276 | 136 |
| 1-277 | 149 |
| 1-280 | 156 |
| 1-282 | 176 |
| 1-283 | 151 |
| 1-284 | 185 |
| | (decomposed) |
| 1-286 | 55-57 |
| 1-293 | 94-96 |
| 1-312 | 113-116 |

TABLE 3-2

| Compd. | |
|---|---|
| No | ¹H-NMR(ppm, 400 MHz in CDCl₃) |
| 1-5 | 3.67(3H, s), 3.82(3H, s), 6.61(1H, t, J=72.4Hz), 7.16(1H, d, J=9.2Hz), |
| | 7.3-7.8(5H, m), 8.2(1H, br s). |
| 1-6 | 2.99(3H, s), 3.77(6H, s), 6.65(1H, t, J=72.0Hz), 7.27(1H, d, J=8.8Hz), |
| | 8.01(1H, s). |
| 1-7 | 2.01(1H, t, J=2.6Hz), 3.74(3H, s), 3.80(3H, s), 6.61(1H, t, J=67.1Hz), |
| | 7.24(1H, d, J=9.2Hz), 8.16(1H, s). |
| 1-8 | 0.92(3H, d, J=6.0Hz), 1.11(3H, d, J=6.0Hz), 3.77(3H, s), 3.82(3H, s), |
| | 4.06(1H, m), 6.64(1H, t, J=72.8Hz), 7.28(1H, d, J=8.8Hz), 8.11(1H, s). |
| 1-9 | 1.82(3H, s), 2.02(3H, s), 3.77(3H, s), 3.80(3H, s), 5.59(1H, s), 6.67(1H, t, |
| | J=72.4Hz), 7.12(1H, d, J=8.8Hz), 7.28(1H, br s). |
| 1-10 | 1.3-1.8(8H, m), 3.76(3H, s), 3.79(3H, s), 3.89(1H, m), 6.62(1H, t, 72.8Hz), |
| | 7.25(1H, d, J=8.8Hz), 8.11(1H, br s). |
| 1-11 | 1.80(3H, s), 1.91(3H, s), 2.03(3H, s), 2.16(3H, s), 3.70(3H, s), 3.77(3H, s), |
| | 5.68(1H, m), 5.82(br s), 6.60(1H, t, J=72.2Hz), 7.26(1H, d, J=8.4Hz). |
| 1-12 | 3.58(3H, s), 3.85(3H, s), 4.88(2H, m), 6.73(1H, t, J=72.8Hz), 7.2-7.8(6H, |
| | m), 8.34(1H, br s). |
| 1-13 | 3.62(3H, s), 3.84(3H, s), 4.7-4.9(2H, m), 6.73(1H, t, 72.8Hz), 7.29(1H, d, |
| | J=8.4Hz), 7.42(2H, d, J=8.8Hz), 7.79(2H, d, J=8.8Hz), 8.32(1H, br s). |
| 1-14 | 1.99(3H, s), 3.74(3H, s), 3.76(3H, s), 4.0-4.1(2H, m), 6.65(1H, t, |
| | J=72.8Hz), 7.20(1H, d, J=4.0Hz), 8.15(1H, br s). |
| 1-15 | 3.66(3H, s), 3.80(3H, s), 4.53(2H, s), 6.67(1H, t, J=72.8Hz), 6.9(2H, m), |
| | 7.06(1H, t, J=7.4Hz), 7.20(1H, d, J=8.8Hz), 7.3(2H, m), 8.66(1H, br s). |
| 1-19 | 1.89(3H, t, J=7.8Hz), 3.77(3H, s), 3.82(3H, s), 3.85-4.28(4H, m), 6.66(1H, |
| | t, J=72.2Hz), 7.25(1H, d, J=9.2Hz), 8.17(1H, s). |
| 1-20 | 3.63(3H, s), 3.75(3H, s), 3.81(3H, s), 6.65(1H, t, J=67.1Hz), 7.25(1H, d, |
| | J=9.2Hz), 8.18(1H, s). |
| 1-21 | 2.46(2H, t, J=7.7Hz), 2.82(2H, t, J=7.7Hz), 3.64(3H, s), 3.68(3H, s), |
| | 6.63(1H, t, J=72.4Hz), 7.0-7.2(6H, m), 7.3(1H, br s). |
| 1-22 | 3.74(3H, s), 3.84(3H, s), 6.65(1H, t, J=72.6Hz), 7.1-7.3(3H, m), 7.5(1H, |
| | m), 8.0(1H, m), 8.75(1H, d, J=12.8Hz). |
| 1-23 | 3.77(3H, s), 3.92(3H, s), 6.72(1H, t, J=72.6Hz), 7.23(1H, d, J=8.8Hz), |
| | 7.3-7.5(4H, m), 8.1(1H, br s). |
| 1-24 | 2.28(3H, s), 3.62(3H, s), 3.80(3H, s), 6.61(1H, t, J=72.4Hz), 7.1-7.3(5H, |
| | m), 7.7(1H, br s). |
| 1-25 | 3.74(3H, s), 3.93(3H, s), 6.71(1H, t, J=72.2Hz), 7.22(1H, d, J=8.4Hz), |
| | 7.4-7.7(4H, m), 7.8(1H, br s). |
| 1-28 | 3.69(3H, s), 3.81(3H, s), 3.82(3H, s), 6.28(1H, t, J=72.4Hz), 7.0(1H, m), |
| | 7.16(1H, d, J=8.8Hz), 7.3(3H, m), 8.2(1H, br s). |
| 1-29 | 3.68(3H, s), 3.80(3H, s), 3.83(3H, s), 6.61(1H, t, J=72.4Hz), 6.90(2H, d, |
| | J=8.8 H.z), 7.14(1H, d, J=8.8Hz), 7.73(2H, d, J=8.8Hz), 8.2(1H, br s). |
| 1-30 | 3.57(3H, s), 3.81(3H, s), 6.66(1H, t, J=70.8Hz), 6.8-6.9(2H, m), 7.19(1H, d, |
| | J=10.0Hz), 8.0(1H, m), 8.69(1H, d, J=13.2Hz). |
| 1-31 | 3.71(3H, s), 3.82(3H, s), 6.42(1H, d, J=16.0Hz), 6.64(1H, t, J=72.4Hz), |
| | 7.16(1H, d, J=8.8Hz), 7.3(3H, m), 7.4(2H, m), 7.57(1H, d, J=16.0Hz), |
| | 7.61(1H, br s). |
| 1-32 | 3.70(3H, s), 3.83(3H, s), 6.64(1H, t, J=72.0Hz), 7.20(1H, d, J=8.8Hz), |
| | 7.73(2H, d, J=8.4Hz), 7.87(2H, d, J=8.4Hz), 8.26(1H, s). |
| 1-33 | 1.53(3H, d, J=6.8Hz), 3.59(3H, s), 3.60(3H, s), 4.61(1H, q, J=6.8Hz), |
| | 6.66(1H, t, J=72.8Hz), 6.8˜7.3(6H, m), 8.47(1H, br s). |
| 1-35 | 3.66(3H, s), 3.79(3H, s), 4.48(2H, s), 6.66(1H, t, J=72.8Hz), 6.8(2H, m), |
| | 7.2-7.3(3H, m), 8.55(1H, br s). |
| 1-37 | 2.26(3H, s), 2.46(2H, t, J=37.9Hz), 2.86(2H, t, J=7.9Hz), 3.74(3H, s), |
| | 3.75(3H, s), 6.68(1H, t, J=72.2Hz), 7.0(4H, m), 7.14(1H, d, J=8.8Hz), |
| | 7.3(1H, br s). |
| 1-39 | 3.58(3H, s), 3.85(3H, s), 3.86(3H, s), 4.8-4.9(2H, m), 6.73(1H, t, |
| | J=72.8Hz), 6.89(2H, d, J=8.8Hz), 7.28(1H, d, J=8.0Hz), 7.82(2H, d, |
| | J=828Hz), 8.34(1H, s). |
| 1-40 | 2.46(2H, m), 3.34(3H, s), 3.6(2H, m), 3.78(3H, s), 3.81(3H, s), 6.68(1H, t, |
| | J=72.8Hz), 7.12(1H, d, 34.8Hz), 8.18(1H, br s). |
| 1-41 | 1.43(3H, d, J=6.8Hz), 3.59(3H, s), 3.60(3H, s), 3.61(1H, q, 6.8Hz), |
| | 6.65(1H, t, J=72.6Hz), 7.08(1H, d, J=8.8Hz), 7.2-7.3(5H, m). |
| 1-42 | 1.12-1.56(6H), 3.68-3.85(6H), 4.07-4.27(3H), 6.47-6.87(1H), |
| | 7.22-7.32(1H), 8.06-8.36(1H). |
| 1-43 | 3.69(3H, s), 3.7-4.0(4H, m), 3.80(3H, s), 6.39(1H, t, J=72.8Hz), 6.68(1H, |
| | d, J=8.8Hz), 6.8-7.3(5H, m), 8.24(1H, s).. |
| 1-44 | 1.52(6H, s), 2.04(3H, s), 3.77(3H, s), 3.82(3H, s), |
| | 6.72(1H, t, J=72.8Hz), 7.14(1H, d, J=8.8Hz), 7.93(1H, s). |
| 1-50 | 2.28(3H, s), 2.49(2H, t, J=7.9Hz), 2.82(2H, t, J=7.9Hz), 3.69(3H, s), |
| | 3.74(3H, s), 6.67(1H, t, J=72.6Hz), 6.9(3H, m), 7.1(2H, m), 7.3(1H, br s). |
| 1-52 | 3.60(4H, t, J=5.2Hz), 3.77(3H, s), 3.88(3H, s), 4.3(4H, m), 6.68(1H, t, |
| | J=72.0Hz), 7.32(1H, d, J=8.8Hz). |
| 1-53 | 2.11(1H, t, J=2.6Hz), 3.77(2H, d, J=2.6Hz), 3.81(3H, s), 3.82(3H, s), |
| | 4.6(1H, br s), 6.71(1H, t, J=72.6Hz), 6.74(1H, d, J=8.4Hz). |
| 1-54 | 3.23(6H, s), 3.5(4H, m), 3.77(3H, s), 3.86(3H, s), 4.17(2H, m), 4.35(2H, |
| | m), 6.67(1H, t, J=72.0Hz), 7.28(1H, d, J=8.8Hz). |
| 1-56 | 3.69(3H, s), 3.78(3H, s), 3.80(3H, s), 4.99(2H, s), 6.67(1H, t, J=72.4Hz), |
| | 6.86(2H, d, 8.8), 7.02(1H, s), 7.11(1H, d, J=8.8Hz), 7.23(2H, d, J=8.8Hz) |
| 1-59 | 0.92(6H, d, J=6.4Hz), 3.35(1H, m), 3.74(3H, s), 3.77(3H, s), 6.58(1H, d, |
| | J=8.8Hz), 6.66(1H, t, J=72.8Hz). |
| 1-60 | 1.3(2H, m), 1.5(4H, m), 1.6(2H, m), 3.7(1H, m), 3.82(6H, s), 6.65(1H, d, |
| | J=9.2Hz), 6.71(1H, t, J=72.8Hz), 7.24(1H, s). |
| 1-63 | 3.74(3H, s), 3.82(3H, s), 5.18(2H, s), 6.69(1H, t, J=72.4Hz), 7.14(1H, d, |
| | J=8.8Hz), 7.14(1H, br s), 7.2(2H, m), 7.3(2H, m) |
| 1-66 | 2.25(6H, s), 2.52(2H, t, J=5.6Hz), 3.81(3H, s), 3.84(3H, s), 4.14(2H, t, |
| | J=5.6Hz), 6.73(1H, t, J=72.4Hz), 7.13(1H, d, J=8.8Hz). |
| 1-76 | 1.11(3H, t, J=7.2Hz), 1.20(3H, d, J=6.8Hz), 3.75(3H, s), 3.78(3H, s), |
| | 3.7-4.1(3H, m), 4.75(1H, br s), 6.62(1H, d, J=8.8Hz), 6.66(1H, t, J=72.4Hz). |
| 1-77 | 3.39(2H, t, J=5.1Hz), 3.67(3H, s), 3.78(3H, s), 3.83(2H, t, J=5.1Hz), |
| | 6.45(1H, t, J=63.1Hz), 6.64(1H, d, J=8.5Hz), 6.69(1H, d, J=8.5Hz), |
| | 6.87(1H, t, J=7.3Hz), 7.2-7.3(2H, m). |
| 1-81 | 3.82(3H, s), 4.89(2H, br s), 6.45(1H, t, J=74.0Hz), 6.58(1H, d, J=9.2Hz), |
| | 6.70(1H, t, J=72.8Hz). |
| 1-86 | 3.68(3H, s), 4.09(1H, d, J=14.7Hz), 5.16(1H, d, J=14.7Hz), 6.35(1H, t, |
| | J=67.0Hz), 6.50(1H, t, J=67.0Hz), 6.9-7.3(6H, m), 8.32(1H, s). |
| 1-87 | 2.04(1H, t, J=0.3Hz), 3.74(2H, d, J=0.3Hz), 3.79(3H, s), 6.47(1H, t, |
| | J=71.7Hz), 6.63(1H, t, J=71.7Hz), 6.79(1H, d, J=8.6Hz). |
| 1-88 | 3.74(3H, s), 4.17(2H, s), 6.58(1H, t, J=76Hz), 6.61(1H, t, J=74.7Hz), |
| | 6.75(1H, d, J=8.0Hz), 7.1(2H, m), 7.2-7.3(3H, m). |
| 1-90 | 3.81(3H, s), 3.82(3H, s), 4.4(2H, br s), 6.52(1H, d, J=10.0Hz), 6.71(1H, t, |
| | J=72.6Hz). |
| 1-251 | 2.03(3H, d, J=0.8Hz), 3.69(3H, s), 3.79(3H, s), 6.62(1H t, J=72.4Hz), |
| | 7.06(1H, d, J=9.2Hz), 7.3-7.4(5H, m), 7.91(1H, br s). |
| 1-252 | 3.77(3H, s), 3.85(3H, s), 6.59(1H, d, J=16.0Hz), 6.67(1H, t, J=72.4Hz), |
| | 7.1(1H, m), 7.32(2H, d, J=8.4Hz), 7.63(1H, d, J=16.0Hz), 7.64(1H, br s). |
| 1-253 | 3.74(3H, s), 3.83(3H, s), 6.56(1H, d, J=15.6Hz), 6.66(1H t, J=72.6Hz), |
| | 7.1-7.5(5H, m), 7.6(1H, br s), 7.65(1H, d, J=15.6Hz). |
| 1-271 | 3.67(3H, s), 3.86(3H, s), 6.61(1H, t, J=72.4Hz), 7.19(1H, d, J=9.2Hz), |
| | 7.6(2H, m), 7.8-7.9(4H, m), 8.32(1H, s), 8.38(1H, br s). |
| 1-273 | 1.31(3H, t, J=7.0Hz), 3.74(3H, s), 3.82(3H, s), 4.29(2H, q, J=7.0Hz), |
| | 6.63(1H, t, J=72.4Hz), 7.14(1H, d, J=8.8Hz), 9.16(1H, br s). |
| 1-278 | 1.23(3H, t, J=7/2Hz), 2.69(2H, q, J=7.2Hz), 3.70(3H, s), 3.81(3H, s), |
| | 6.62(1H, t, J=72.6Hz), 7.16(1H, d, J=8.8Hz), 7.25(2H, d, J=8.4Hz), |
| | 7.71(2H, d, J=8.4Hz), 8.24(1H, br s). |
| 1-279 | 3.02(6H, s), 3.70(3H, s), 3.80(3H, s), 6.61(1H, t, J=72.6Hz), 6.70(2H, d, |
| | J=9.2Hz), 7.12(1H, d, J=8.8Hz), 7.71(2H, d, J=9.2Hz), 8.16(1H, br s). |
| 1-281 | 3.73(3H, s), 3.80(6H, s), 3.82(3H, s), 6.6(1H, m), 6.64(1H t, J=72.2Hz), |
| | 6.9(2H, m), 7.17(1H, d, J=8.8Hz), 8.23(1H, br s). |
| 1-285 | 1.2(1H, m), 1.5(1H, m), 1.7(1H, m), 2.3(1H, m), 3.71(3H, s), 3.82(3H, s), |
| | 6.67(1H, t, J=72.2Hz), 7.0-7.2(6H, m), 7.48(1H, br s). |
| 1-287 | 3.76(3H, s), 3.82(3H, s), 5.15(2H, s), 6.67(1H, t, J=72.2Hz), 6.96(1H, br |
| | d), 7.14(1H, d, J=8.8Hz), 7.50(1H, m), 7.59(1H, d, J=7.2Hz), 8.15(2H, m). |
| 1-288 | 3.80(3H, s), 3.91(3H, s), 4.09(2H, m), 4.34(1H, q, J=7.2Hz), 4.46(1H, q, |
| | J=7.2Hz), 6.74(1H, t, J=72.4Hz), 7.29(1H, d, J=8.8Hz) |
| 1-292 | 2.20(1H, t, J=2.6Hz), 2.74(3H, s), 3.69(2H, d, J=2.6Hz), 3.82, 3.84(each |
| | 3H, s), 6.72(1H, t, 72.8Hz), 6.93(1H, d, J=8.8Hz) |
| 1-294 | 3.65(3H, s), 3.73(2H, s), 3.75(3H, s), 3.83(3H, s), 5.14(1H, br.s), 6.63(1H, |
| | d, J=8.4Hz), 6.71(1H, t, J=72.8Hz) |
| 1-295 | 1.56-1.64(1H, m), 1.85-1.97(3H, m), 3.46-3.50(1H, m), 3.56-3.60(1H, m), |
| | 3.70-3.85(2H, m), 3.77, 3.82(each 3H, each s), 3.94-4.12(3H, m), 6.6(1H, t, |
| | J=72.8Hz), 7.15(1H, d, J=8.4Hz), 8.71(1H, br.s) |
| 1-299 | 3.72(3H, s), 3.83(3H, s), 4.53(2H, s), 6.70(1H, t, J=72.2Hz), 6.79-6.82(1H, |
| | m), 6.94-6.95(1H, m), 7.05-7.07(1H, m), 7.20-7.28(2H, m), 8.59(1H, br.s). |
| 2-21 | 3.79(3H, s), 3.97(3H, s), 6.67(1H, t, J=72.0Hz), 7.37(1H, d, J=8.4Hz). |

Herbicidal Activity

The compounds of the present invention exhibit excellent herbicidal effect when used as an active ingredient of a herbicide. The herbicide can be used for a wide range of applications, for example on croplands such as paddy fields, upland fields, orchards, vineyards and mulberry fields, and non-crop lands such as forests, turf, right of way, roadsides, railroads, playgrounds and factory sites. The application method may be suitable selected for soil treatment application, foliar application and water application.

The compounds of the present invention are capable of controlling noxious weeds including grass (gramineae) such as barnyardgrass (Echinochloa crus-galli L.), crabgrass (Digitaria sanguinalis L.), green foxtail (Setana virids L.), goosegrass (Eleusine indica L.), wild oat (Avena fatua L.), johnsongrass (Sorghum halepense L.), quackgrass (Agropyron repens L.), alexandergrass (Brachiaria plantaginea), paragrass (Panicum purpurascens), sprangletop (Leptochloa chinensis) and red sprangletop (Leptochloa panicea); sedges (or Cyperaceae) such as rice flatsedge (Cyperus iria L.), purple nutsedge (Cyerus rotundus L.), japanese bulrush (Scirpus juncoides), flatsedge (Cyperus serotinus), smallflower umbrellaplant (Cyperus difformis L.), slender spikerush (Eleochcaris acicularis L.), and water chestnut (Eleocharis kuroguwai); alismataceae such as japanese ribbon wapato (Sagittaria pygmaea), arrow-head (Sagittaria trifolia L.) and narrowleaf waterplantain (Alisma canaliculatum); pontederiaceae such as monochoria (Monochoria vaginalis) and monochoria species (Monochoria korsakowii); scrophulariaceae such as falsepimpernel (Lindernia pyxidaria) and dopatrium (Dopatrium junceum); lythraceae such as toothcup (Rotala indica) and red stem (Ammannia multiflora), and broadleaves such as redroot pigweed (Amaranthus retroflexus L.), velvetleaf (Abutilon theophrasti), morningglory (Ipomoea hederacea L.), lambsquaters (Chenopodium album L.), prickly sida (Sida spinosa L.), common purslane (Portulaca oleracea L.), slender amaranth (Amaranthus virdis L.), sicklepod (Cassia obtusifolia L.), black nightshade (Solanum nigrum L.), pale smartweed (Polygonum lapathifolium L.), common chcikweed (Stellaria media L.), common cocklebur (Xanthium strumarium L.), flexuous bittercress (Cardamine flexuosa), henbit (Lamium amplexicaule L.) and threeseeded copperleaf (Acalypha australis L.). Accordingly, it is useful for controlling noxious weeds non-selectively or selectively in the cultivation of a crop plant such as corn (Zea mays L.), soybean (Glycine max Merr.), cotton (Gossypium spp.), wheat (Triticum spp.), rice (Oryza sativa L.), barley Hordeum vulgare L.), oats (Avena sativa L.), sorgo (Sorghum bicolor Moench), rape (Brassica napus L., Brassica campestris L.), sunflower (Helianthus annuus L.), sugar beet (Beta vulgaris L.), sugar cane (Saccharum officinarum L.), japanese lawngrass (Zoysia japonica Steud), peanut (Arachis hypogaea L.) or flax (Linum usitatissimum L.). The compound of the present invention is particularly effective for selectively controlling noxious weeds in the cultivation of corn, wheat, rice, soybean or cotton, especially in the cultivation of corn, soybean, wheat and rice.

For the use as herbicides, the active ingredients of this invention are formulated into herbicidal compositions by mixing herbicidal active amounts with inert ingredients known to the art to facilitate either the suspension, dissolution or emulsification of the active ingredient for the desired use. The type of formulation prepared recognizes the facts that formulation, crop and use pattern all can influence the activity and utility of active ingredient in a particular use. Thus for agricultural use the present herbicidal compounds may be formulated as water dispersible granules, suspension concentrates, tablets, capsules, wettable powders, dusts, solutions, emulsifiable concentrates TIC), microemulsion, suspoemulsion, invert emulsion or other type of formulations, depending on the desired weed targets, crops and application methods. However, so long as it is suitable for the purpose of the present invention, it may be formulated into any type of formulation that is commonly used in this field.

These herbicidal formulations may be applied to the target area (Where suppression of unwanted vegetation is the objective) as dusts, granules, tablets, capsules or water or solvent diluted sprays. These formulation may be contain as little as 0.1% to as much as 97% active ingredient by weight.

Dusts are admixtures of the active ingredient with finely ground materials such as clays (some examples include kaolin and montmorillonite clays), talc, granite dust or other organic or inorganic solids which act as dispersants and carriers for the active ingredient; these finely ground materials have an average particle size of less than 50 microns. A typical dust formulation will contain 1% active ingredient and 99% carrier.

Wettable powders are composed of finely ground particles which disperse rapidly in water or other spray carriers. Typical carriers include kaolin clays, fullers earth, silicas and other absorbent, wettable inorganic materials. Wettable powders can be prepared to contain from 0.1 to 90% active ingredient, depending on the desired use pattern and the absorbability of the crier. Wettable powders typically contain wetting or dispersing agent to assist dispersion in water or other carriers.

Water dispersible granules are granulated solids that freely disperse when mixed in water. This formulation typically consists of the active ingredient (0.1% to 95% active ingredient), a wetting agent (1 to 15% by weight), a dispersing agent (1 to 15% by weight) and an inert carrier (1 to 95% by weight). Water dispersible granules can be formed by mixing the ingredients intimately then adding a small amount of water on a rotating disc (said mechanism is commercially available) and collecting the agglomerated granules. Alternatively, the mixture of ingredients may be mixed with an optimal amount of liquid (water or other liquid) and passed through an extruder (said mechanism is commercially available) equipped with passages which allow for the formulation of small extruded granules. Alternatively, the mixture of ingredients can be granulated using a high speed mixer (said mechanism is commercially available) by adding a small amount of liquid and mixing at high speeds to affect agglomeration. Alternatively, the mixture of ingredient can be dispersed in water and dried by spraying the dispersion through a heated nozzle in a process known as spray drying (spray drying equipment is commercially available). After granulation the moisture content of granules is adjusted to an optimal level (generally less than 5%) and the product is sized to the desired mesh size.

Granules are granulated solids that do not disperse readily in water, but instead maintain their physical structure when applied to the soil or water using a dry granule applicator or by hand. These granulated solids may be made of clay, vegetable material such as corn cob grids, agglomerated silicas or other agglomerated organic or inorganic materials or compounds such as calcium sulfate. The formulation typically consists of the active ingredient (1 to 20%) dispersed on or absorbed into the granule. The granule may be produced by intimately mixing the active ingredient with the granules with or without a sticking agent to facilitate adhesion of the active ingredient to the granule surface, or by dissolving the active ingredient in a solvent spraying the dissolved active ingredient and solvent onto the granule then drying to remove the solvent. Granular formulations are useful where in-furrow or banded application is desired.

Emulsifiable concentrates (EC) are homogeneous liquids composed of a solvent or mixture of solvent such as xylenes, heavy aromatic naphthas, isophorone or other proprietary commercial compositions derived from petroleum distillates, the active ingredient and an emulsifying agent or agents. For herbicidal use, the EC is added to water (or other spray carrier) and applied as a spray to the target area. The composition of an EC formulation can contain 0.1% to 95% active ingredient, 4 to 95% solvent or solvent mixture and 1 to 20% emulsifying agent or mixture of emulsifying agent.

Suspension concentrate (also known as flowable) formulations are liquid formulations consisting of a finely ground suspension of the active ingredient in a carrier, typically water or a non-aqueous carrier such as an oil. Suspension concentrates typically contain the active ingredient (0.1 to 50% by weight), carrier, wetting agent, dispersing agent, anti-freeze, viscosity modifiers and pH modifiers. For application, suspension concentrates are typically diluted with water and sprayed on the target area or they are directly applied to flooded water in paddy field.

Microemulsions are solutions consisting of the active ingredient (1 to 30%) dissolved in a surfactant or emulsifier, with additional solvents. Microemulsions are particularly useful when a low odor formulation is required such as in residential turfgrass applications.

Suspoemulsions are combinations of two active ingredients. One active ingredient is made as a suspension concentrate (1 to 50% active ingredient) and the second active ingredient is made as an emulsifiable concentrate (0.1 to 20%). A reason for making this kind of formulation is the inability to make an EC formulation of the first ingredient due to poor solubility in organic solvents. The suspoemulsion formulation allows for the combination of the two active ingredients to be packaged in one container, thereby minimizing packaging waste and giving greater convenience to the product user.

The herbicidal compounds of this invention may be formulated or applied with insecticides, fungicides, acaricides, nematicides, fertilizers, plant growth regulators or other agricultural chemicals. Certain tank mix additives, such as spreader stickers, penetration aids, wetting agents, surfactants, emulsifiers, humectants and LV protectants may be added in amount of 0.01% to 5% to enhance the biological activity, stability, wetting, spreading on foliage or uptake of active ingredients on the target area or to improve the suspensibility, dispersion, redispersion, emulsifiability, UV stability or other physical or physico-chemical property of the active ingredient in the spray tank, spray system or target area.

The dose of the herbicidal composition of the present invention can not generally be defined, since it may be vary depending upon the weather condition, the soil condition, the type of the formulation, the types of the weeds to controlled, season for application, etc. However, it is usually applied so that the compound of the present invention would be applied in an amount of from 0.5 to 5000 g/ha, preferably from 1 to 1000 gala, more preferably from 5 to 500 g/ha. The present invention covers such a method for controlling noxious weeds by application of such a herbicidal composition.

The herbicidal compositions of the present invention may be used in admixture with or in combination with other agricultural chemicals, fertilizers, adjuvants, surfactants, emulsifiers, oils, polymers and phytotoxicity-reducing agent such as herbicide safeners. In such a case, they may exhibit even better effects or activities. As other agricultural chemicals, herbicides, fungicides, antibiotics, plant hormones, plant growth regulators, insecticides or acaricides nay, for example, be mentioned. Especially with herbicidal compositions having the compounds of the present invention used in admixture with or in combination with one or more active ingredients of other herbicides, it is possible to improve the herbicidal activities, the range of application time(s) and the range of applicable weed types. Further, the compounds of the present invention and an active ingredient of another herbicide may be separately formulated so they may be mixed for use at the time of application, or both may be formulated together. The present invention covers such herbicidal compositions.

The blend ratio of the compounds of the present invention with the active ingredient of other herbicides can not generally be defined, since it varies depending on the time and method of application, weather conditions, soil type and type of formulation, etc. However one active ingredient of other herbicide may be incorporated usually in an amount of 0.001 to 10000 parts by weight, preferably from 0.01 to 1000 parts by weight, per one part by weight of compounds of present invention. Further, the total dose of all of the active ingredients is usually from 0.1 to 10000 g/ha, preferably from 0.2 to 5000 g/ha. The present invention covers a method for controlling noxious weeds by application of such herbicidal compositions.

As the active ingredient of the other herbicides, non-limiting examples of which are mentioned below (common name or experimental number). Herbicidal compositions having the compounds of the present invention used in combination with other herbicides may be occasionally exhibit a synergistic effect.
1. Those that are believed to exhibit herbicidal effects by disturbing hormone activities of plants, including a phenoxy acetic acid type such as 2,4-D, 2,4-DB, 2,4-DP, MCPA, MCPP, MCPB or naproanilide (including the free acids, esters or salts thereof), an aromatic carboxylic type such as 2,3,6 TBA, dicamba or dichlobenil, a pyridine type such as picloram (including the free acids and salts thereof), triclopyr, clopyralid, aminopyralid (DE-750) or fluroxypyr and others such as naptalam, benazolin, quinclorac, quinmerac, diflufenzopyr or thiazopyr.
2. Those that are believed to exhibit herbicidal effects by inhibiting photosynthesis of plants including a urea type such as diuron, linuron, isoproturon, chlorotoluron, metobenzuron, tebuthiuron or fluometuron, a triazine type such as simazine, atrazine, cyanazine, terbuthylazine, atraton, hexazinone, metribuzin, simetryn, prometryn dimethametryn, triaziflam, propazine or ametryn, uracil type such as bromacil, terbacil or lenacil, an anilide type such as propanil or cypromid, a carbamate type such as swep, desmedipham or phenmedipham, a hydroxybenzonitrile type such as bromoxynil, bromoxynil-octanoate or ioxynil, and others such as pyridate, bentazon, amicarbazone or methazole.
3. A quaternary ammonium salt type such as paraquat, diquat or difenzoquat, which is believed to form active oxygen in the plant and thus to exhibit quick herbicidal effects,
4. Those which are believed to exhibit herbicidal effects by inhibiting chlorophyll biosynthesis in the plant body and abnormally accumulating a photosensitizing peroxide substance in the plant body, including a diphenyl ether type such as nitrofen, lactofen, ethoxyfen-ethyl, acifluorfen-sodium, oxyfluorfen, fomesafen, bifenox or chlomethoxyfen, a cyclic imide type such as chlorphthalim, flumioxazin, cinidon-ethyl or flumiclorac-pentyl, and others such as oxadiazon, sulfentrazone, thidiazimin, azafenidin, carfentrazone-ethyl, isopropazole, fluthiacet-methyl, pentoxazone, pyraflufen-ethyl, benzfendizone, butafenacil, metobenzuron, flupoxam, fluazolate, flufenpyr-ethyl, profluazol, pyrachlonil or oxadiargyl.
5. Those which are believed to exhibit herbicidal effects characterized by whitening activities by inhibiting chromogenesis of plants such as carotenoids including a pyridazinone type such as norflurazon, chloridazon or metflurazon, a pyrazol type such as pyrazolate, pyrazoxyfen, benzofenap or BAS-670H and others such as fluridone, flurtamone, diflufenican, methoxyphenone, clomazone, amitrole, sulcotrione, mesotrione, isoxaflutole, isoxachlortole, bezobicyclon, picolinafen or beflubutamid.
6. Those which exhibit herbicidal effects specifically to gramineous plants including an aryloxyphenoxypropoinic acid type (either as a mixture of isomers or as a resolved isomer) such as diclofop-methyl, pyriphenop-sodium, fluazifop-butyl, haloxyfop-methyl, quizalofop-ethyl, metamifop, fenoxaprop-ethyl, propaquizafop, fenthiaprop-ethyl, flamprop-methyl, chlorazifop-propynyl, clodinafop-propargyl or cyhalofop-butyl, and a cyclohexanedione type such as alloxydim-sodium, clethodim, cycloxydim, profoxydim, tepraloxydim, tralkoxydim, butroxydim, caloxydim, clefoxydim or sethoxydim and the others such as pinoxaden (NOA407855).
7. Those which are believed to exhibit herbicidal effects by inhibiting amino acid biosynthesis of plants, including a sulfonylurea type such chlorimuron-ethyl, nicosulfuron, metsulfuron-methyl, triasulfuron, primisulfuron, tribenuron-methyl, chlorsulfuron, bensulfuron-methyl, sulfometuron-methyl, prosulfuron, halosulfuron or halosulfuron-methyl, thifensulfuron-methyl, rimsulfuron, azimsulfuron, flazasulfuron, imazosulfuron, cyclosulfamuron, flupyrsulfuron, iodosulfuron, ethoxysulfuron, cinosulfuron, pyrazosulfuron-ethyl, trisulfuron-methyl, ethametsulfuron, flupyrsulfuron, triflusulfuron-methyl, mesosulfuron (amosulfuron), amidosulfuron, tritosulfuron, foramsulfuron, trifloxysulfuron, sulfosulfuron or oxasulfuron, and a triazolopyrimidinesulfonamide type such as flumetsulam, metosulam, chloransulam, chloransulam-methyl, diclosulam, florasulam, metosulfam or penoxsulam, an imidazolinone type such as imazapyr, imazethapyr, imazaquin, imazamox, imazameth, imazapic or imazamethabenz-methyl, a pyrimidinesalicylic acid type such as pyrithiobac-sodium, bispyribac-sodium, pyriminobac-methyl, pyribenzoxim, KUH-021 or pyriftalid, a sulfonylaminocarbonyltriazolinone type such as flucarbazone-sodium or propoxycarbazone-sodium (MKH6561), and others such as glyphosate, glyphosate-ammonium, glyphosate-isopropylamine, sulfosate, glufosinate, glufosinate-ammonium, phosphinothricin or bialaphos.
8. Those which are believed to exhibit herbicidal effects by inhibiting cell division of plant cell, including a dinitroaniline type such as trifluralin, oryzalin, nitralin, pendimethalin, ethafluralin, benefin or prodiamine, an amide type such as bensulide, napronamide or pronamide, a carbamate type such as propham, chlorpropham, barban or asulam, a cumylamine type such as daimuron, cumyluron or bromobutide, an organophosphorous type such as amiprofos-methyl, butamifos, anilofos or piperophos, and others such as DCPA, dithiopyr or thiazopyr.
9. Those which are believed to exhibit herbicidal effects by inhibiting lipid synthesis of plant cells, including a chloroacetanilide type such as alachlor, metolachlor (including combinations with safeners such as benoxacor, or resolved isomeric mixtures of metolachlor including safeners such as nenoxacor), propachlor, acetochlor (including combinations with herbicide safeners such as dichlomid or MON-4660, or resolved isomeric mixtures of acetochlor containing safeners such as dichlomid or MON-1660), propisochlor, butachlor, pretilachlor, thenylchlor, pethoxamide or dimethenamid, an oxyacetaride type such as flufenact or mefenacet, and others such as etobenzanid, tridiphane, cafenstrol, fentrazamide, oxaziclomefone, amicarbazone or indanofan.
10. Those in which the mode of action causing the herbicidal effects are not well understood including the thiocarbamates such as thiobencarb, EPTC, diallate, triallate, molinate, pebulate, cycloate, butylate, vernolate, prosulfocarb, dimepiperate, fenazolate, esprocarb or pyributicarb, and miscellaneous herbicides such as MSMA, DSMA, endothall, ethofumesate, sodium chlorate, pelargonic acid or fosamine.
11. Those which are believed to exhibit herbicidal effects by infestation on the plant bodies, including a biological herbicide such as Xanthomonas campestris, Epicoccosiarus nematosurus, Exserohilum monoseras, Drechsrela monoceras.

A few formulation examples of the present invention are given as follows.

### FORMULATION EXAMPLE 1

### Water-Dispersible Granule

| | Trade Name | Chemical Name | Supplier | % wt./wt |
|---|---|---|---|---|
| (1) | Compound of this | | | 75 |
| | invention | | | |
| (2) | Geropon T-77 | Sodium | Rhone-Poulenc | 14.5 |
| | | N-methyl-N-oleoyl | | |
| | | taurate | | |
| (3) | NaCl | | | 10 |
| (4) | Dextrin | | | 0.5 |

The above pulverized components are placed in a high-speed mixing granular, admixed with 20 wt % of water, granulated, and dried to form water-dispersible granules.

### FORMULATION EXAMPLE 2

### Wettable Powder

| | Trade Name | Chemical Name | Supplier | % wt./wt |
|---|---|---|---|---|
| (1) | Compound of this | | | 10 |
| | invention | | | |
| (2) | Kaolin clay | | | 70.2 |
| (3) | Laveline FAN | Condensate of sodium napthalene | Dai-ichi Kogyo | 1.8 |
| | | sulfate and formalin | Seiyaku co., Ltd. | |
| (4) | Sorpol 5039 | Sodium polyoxyethlene alkylaryl | Toho Chemical | 4.5 |
| | | ether sulfate-premix with white | Industry Co., Ltd | |
| | | carbon | | |
| (5) | Carplex | White carbon | Shionogi Seiyaku | 13.5 |
| | | | Co., Ltd. | |

The above pulverized components (2) to (5) and compound (1) are mixed to obtain a wettable powder.

### FORMULATION EXAMPLE 3

### Wettable Powder

| | Trade Name | Chemical Name | Supplier | % wt./wt |
|---|---|---|---|---|
| (1) | Compound of this | | | 60 |
| | invention | | | |
| (2) | Hi-Filler No. 10 | Talc micropowder | Matsumura Sangyo | 33 |
| | | | Co., Ltd. | |
| (3) | Sorpol 5050 | Dialkyl sulsosuccinate-premixed | Toho Chemical | 3 |
| | | with white carbon | Industry Co., Ltd | |
| | | A mixture of polyoxyethlene | | |
| | | alkylaryl ether sulfate and a | | |
| (4) | Sorpol 5073 | polyoxyethylene monomethyl | Toho Chemical | 4 |
| | | ether carbonate, premixed with | Industry Co., Ltd. | |
| | | white carbon | | |

The above pulverized compound (1) and the components (2) to (4) are mixed to obtain a wettable powder.

### FORMULATION EXAMPLE 4

### Granule

| | Trade Name | Chemical Name | Supplier | % wt./wt |
|---|---|---|---|---|
| (1) | Compound of this | | | 4 |
| | invention | | | |
| (2) | Bentonite | | | 30 |
| (3) | Calcium carbonate | | | 61.5 |
| (4) | Toxanon GR-31A | Polycarboxylic acid type | Sanyo Chemical | 3 |
| | | surfactant | Industries Co., Ltd | |
| (5) | Calcium lignin sulfonate | | | 1.5 |

Pulverized compound (1), components (2) and (3) are preliminarily mixed, and then components (4), (5) and water are mixed thereto. The mixture is extruded and granulated, followed by drying and size-adjusting to obtain granules,

### FORMULATION EXAMPLE 5

### Water-Dispersible Granule

| | Trade Name | Chemical Name | Supplier | % wt./wt |
|---|---|---|---|---|
| (1) | Compound of this | | | 30 |
| | invention | | | |
| (2) | Zieclite | A pulveried product of a mixture of | Zieclite Co., Ltd | 60 |
| | | kaolinite and sericite | | |
| (3) | New Kalgen WG-1 | Alkyl naphalene sulfonate | Takemoto Oil and Fats | 5 |
| | | | Co., Ltd. | |
| (4) | New Kalgen FS-7 | Polyoxyalkylene allyl phenyl ether | Takemoto Oil and Fats | 5 |
| | | sulfate | Co., Ltd. | |

Compound (1), components (2) and (3) are mixed and passed through a pulverizer, and then component (4) and water are added thereto. The mixture is kneaded and extruded and granulated, followed by drying and size-adjusting to obtain water-dispersible granules.

### FORMULATION EXAMPLE 6

### Water-Based Suspension Concentrate

| | Trade Name | Chemical Name | Supplier | % wt./wt |
|---|---|---|---|---|
| (1) | Compound of this | | | 28 |
| | invention | | | |
| (2) | Saprophor FL | Triethanolamine salts of | Rhonc-Poulonc | 2 |
| | | oxyethlated polyarylphenol | | |
| | | phosphate | | |
| (3) | Sorpal 355 | A mixture of polyoxyethylene | Toho Chemical Industry | 1 |
| | | styryl phenyl ether and alkyl aryl | Co., Ltd. | |
| | | sulfonate | | |
| (4) | IP solvent 1620 | Isoparaffin hydrocarbon | Idemitsu Petrochemical | 32 |
| | | | Co., Ltd. | |
| (5) | Ethylene glycol | | | 6 |
| (6) | Water | | | 31 |

The compound (1) and the above components (2) to (6) are mixed and ground by a wet-milling machine (Dyno-mill) to obtain a water based suspension concentrate.

The herbicidal properties of the compounds of this invention were discovered in a number of greenhouse tests, The test procedures and results follow.

### TEST EXAMPLE 1

Upland field soil was put into a 1/170,000 ha pot, and seeds of various plants {1. barnyardgrass (Echinochloa crus-galli L.): ECHCG, 2. crabgrass (Digitaria sanguinalis L.): DIGSA, 3. green foxtail (Setaria viridis L.): SETVI, 4. redroot pigweed (Amaranthus retroflexus L.): AMARE, 5. prickly sida (Sida spinosa L.): SEDSP, 6. velvetleaf (Abutilon theophrasti): ABUTH, 7. common cocklebur (Xanthium strumarium L.): XANST, 8. rice (Oryza sativa L.): ORYSA, 9. wheat (Triticum aestivum L.): TRZAX, 10. corn (Zea mays L.): ZEAMX, 11. soybean (Glycine max Merr.): GLXMA} were sown. Then, one day after the sowing, a wettable powder or emulsifiable concentrate having the compound of the present invention formulated in accordance with a usual formulation method, was weighed so that the active ingredient would be a predetermined amount and diluted with water in an amount of 500 L/ha. The herbicide adjusted was applied by a small size sprayer for preemergence treatment. On the 20^{th} to 23^{rd} day after the application of the herbicide, the growth of the respective plants was visually observed, and the herbicidal effects were evaluated by growth controlling degrees (%) ranging from 0 (equivalent to the untreated control) to 100 (complete kill), whereby the results shown in Table 4, were obtained. Compound Nos. in Table 4 correspond to Compound Nos. in Table 1 and 2 given hereinbefore.

TABLE 4
Pre-emergence Herbicidal Activity

| Compound | Rate | | | | | | | | | | | |
|---|---|---|---|---|---|---|---|---|---|---|---|---|
| No. | g a.i./ha | ECHCG | DIGSP | SETVI | AMARE | SIDSP | ABUTH | XANST | ORYSA | TRZAX | ZEAMX | GLXMA |
| 1-3 | 63 | 100 | 100 | 100 | 100 | 100 | 100 | — | 80 | 40 | 50 | 20 |
| 1-4 | 63 | 95 | 100 | 100 | 100 | 100 | 100 | — | 80 | 40 | 40 | 40 |
| 1-6 | 63 | 20 | 100 | 50 | 100 | 40 | 50 | — | 20 | 20 | 30 | 0 |
| 1-7 | 125 | 70 | 100 | 95 | 100 | 90 | 80 | — | 20 | 20 | 0 | 10 |
| 1-8 | 63 | 70 | 60 | 100 | 100 | 100 | 100 | — | 60 | 50 | 40 | 70 |
| 1-9 | 63 | 80 | 98 | 100 | 100 | 100 | 100 | 70 | 80 | 40 | 70 | 90 |
| 1-10 | 63 | 90 | 60 | 100 | 100 | 100 | 100 | 100 | 70 | 40 | 40 | 50 |
| 1-11 | 63 | 70 | 40 | 100 | 100 | 100 | 100 | 30 | 40 | 20 | 30 | 50 |
| 1-12 | 63 | 70 | 30 | 95 | 100 | 100 | 100 | 50 | 40 | 20 | 10 | 40 |
| 1-13 | 63 | 80 | 70 | 90 | 100 | 100 | 100 | 50 | 70 | 30 | 40 | 50 |
| 1-14 | 63 | 98 | 98 | 100 | 100 | 100 | 100 | 100 | 40 | 40 | 40 | 60 |
| 1-15 | 63 | 70 | 100 | 100 | 100 | 60 | 60 | — | 40 | 30 | 10 | 30 |
| 1-16 | 63 | 100 | 100 | 100 | 100 | 100 | 100 | — | 40 | 10 | 40 | 10 |
| 1-18 | 125 | 70 | 98 | 50 | 100 | 60 | 40 | — | 50 | 30 | 0 | 20 |
| 1-19 | 125 | 0 | 50 | 10 | — | 50 | 20 | — | 0 | 0 | 20 | 0 |
| 1-20 | 125 | 10 | 30 | 10 | 100 | 98 | 80 | — | 0 | 0 | 0 | 10 |
| 1-21 | 63 | 95 | 100 | 100 | 100 | 100 | 100 | — | 40 | 0 | 20 | 10 |
| 1-22 | 63 | 80 | 100 | 100 | 100 | 100 | 100 | — | 50 | 10 | 20 | 50 |
| 1-23 | 63 | 80 | 100 | 95 | 100 | 100 | 90 | — | 40 | 40 | 0 | 30 |
| 1-24 | 63 | 95 | 100 | 100 | 100 | 100 | 100 | — | 60 | 20 | 10 | 10 |
| 1-25 | 63 | 60 | 98 | 95 | 100 | 100 | 100 | — | 40 | 0 | 0 | 0 |
| 1-26 | 63 | 70 | 98 | 100 | 100 | 70 | 100 | — | 30 | 10 | 10 | 10 |
| 1-27 | 63 | 30 | 100 | 80 | 100 | 80 | 70 | — | 20 | 0 | 0 | 20 |
| 1-28 | 63 | 80 | 100 | 100 | 100 | 100 | 100 | — | 60 | 20 | 0 | 20 |
| 1-29 | 63 | 80 | 100 | 100 | 100 | 100 | 100 | — | 40 | 10 | 20 | 20 |
| 1-30 | 63 | 60 | 100 | 100 | 100 | 100 | 100 | — | 10 | 0 | 10 | 10 |
| 1-31 | 63 | 80 | 100 | 100 | 100 | 100 | 100 | — | 50 | 10 | 10 | 10 |
| 1-32 | 63 | 95 | 100 | 100 | 100 | 100 | 100 | — | 60 | 10 | 10 | 10 |
| 1-33 | 63 | 30 | 40 | 50 | 95 | 50 | 40 | — | 10 | 10 | 0 | 0 |
| 1-34 | 63 | 0 | 60 | 70 | 100 | 70 | 30 | — | 0 | 0 | 0 | 0 |
| 1-35 | 63 | 20 | 50 | 80 | 100 | 20 | 20 | — | 40 | 20 | 0 | 0 |
| 1-36 | 63 | 10 | 30 | 60 | 100 | 20 | 30 | — | 10 | 0 | 0 | 0 |
| 1-37 | 63 | 60 | 100 | 80 | 100 | 95 | 40 | — | 20 | 30 | 0 | 0 |
| 1-38 | 63 | 0 | 10 | 20 | 20 | 0 | 0 | — | 0 | 0 | 0 | 0 |
| 1-40 | 63 | 100 | 100 | 100 | 100 | 100 | 100 | — | 80 | 60 | 60 | 30 |
| 1-41 | 10 | 30 | 50 | 100 | 50 | 40 | 0 | — | 0 | 0 | 0 | 0 |
| 1-42 | 125 | 0 | 0 | 0 | 0 | 0 | 0 | — | 0 | 0 | 0 | 0 |
| 1-43 | 125 | 0 | 10 | 0 | — | 0 | 0 | — | 10 | 0 | 0 | 0 |
| 1-44 | 63 | 10 | 100 | 20 | 100 | 100 | 60 | — | 10 | 10 | 0 | 0 |
| 1-45 | 63 | 0 | 90 | 40 | 100 | 0 | 30 | — | 30 | 10 | 0 | 0 |
| 1-50 | 63 | 70 | 100 | 100 | 100 | 100 | 100 | — | 20 | 30 | 10 | 10 |
| 1-52 | 125 | 0 | 30 | 50 | 100 | 0 | 0 | — | 0 | 0 | 0 | 0 |
| 1-53 | 63 | 100 | 100 | 100 | 100 | 100 | 100 | — | 50 | 20 | 20 | 30 |
| 1-54 | 125 | 20 | 100 | 100 | 100 | 95 | 80 | — | 30 | 20 | 0 | 10 |
| 1-55 | 125 | 50 | 95 | 100 | 100 | 95 | 70 | — | 10 | 20 | 0 | 0 |
| 1-56 | 63 | 50 | 70 | 80 | 100 | 70 | 60 | — | 20 | 0 | 10 | 0 |
| 1-57 | 63 | 70 | 80 | 95 | 100 | 70 | 60 | — | 20 | 30 | 0 | 0 |
| 1-58 | 63 | 100 | 100 | 100 | 100 | 100 | 95 | — | 60 | 10 | 0 | 20 |
| 1-59 | 63 | 60 | 100 | 100 | 100 | 100 | 95 | — | 50 | 30 | 10 | 30 |
| 1-60 | 63 | 0 | 10 | 30 | 95 | 0 | 30 | — | 0 | 0 | 0 | 0 |
| 1-61 | 63 | 100 | 100 | 100 | 100 | 100 | 100 | — | 70 | 50 | 30 | 10 |
| 1-62 | 63 | 100 | 100 | 100 | 100 | 100 | 100 | — | 80 | 60 | 30 | 20 |
| 1-63 | 63 | 30 | 40 | 30 | 100 | 20 | 30 | — | 0 | 10 | 0 | 0 |
| 1-64 | 63 | 40 | 90 | 80 | 100 | 80 | 60 | — | 10 | 10 | 0 | 0 |
| 1-65 | 125 | 0 | 0 | 10 | 20 | 10 | 10 | — | 0 | 0 | 0 | 0 |
| 1-66 | 63 | 0 | 20 | 10 | — | 20 | 20 | — | 0 | 0 | 0 | 0 |
| 1-67 | 63 | 50 | 100 | 100 | 100 | 80 | 70 | — | 40 | 10 | 0 | 0 |
| 1-68 | 63 | 95 | 100 | 100 | 100 | 100 | 100 | — | 40 | 40 | 10 | 0 |
| 1-69 | 63 | 80 | 100 | 100 | 100 | 100 | 100 | — | 10 | 0 | 10 | 10 |
| 1-70 | 63 | 90 | 80 | 70 | 100 | 100 | 100 | — | 40 | 0 | 0 | 0 |
| 1-71 | 63 | 98 | 100 | 100 | 100 | 100 | 100 | — | 60 | 30 | 30 | 10 |
| 1-72 | 63 | 98 | 100 | 100 | 100 | 100 | 100 | — | 40 | 40 | 10 | 0 |
| 1-73 | 63 | 30 | 20 | 60 | 100 | 20 | 10 | — | 10 | 0 | 0 | 0 |
| 1-74 | 63 | 90 | 100 | 100 | 100 | 100 | 100 | — | 50 | 30 | 10 | 0 |
| 1-75 | 63 | 70 | 100 | 100 | 100 | 60 | 100 | — | 30 | 30 | 10 | 0 |
| 1-76 | 63 | 60 | 100 | 60 | 100 | 60 | 40 | — | 10 | 0 | 0 | 0 |
| 1-77 | 63 | 0 | 0 | 10 | — | 0 | 0 | — | 0 | 0 | 0 | 0 |
| 1-81 | 63 | 90 | 100 | 100 | 100 | 100 | 100 | 60 | 20 | 20 | 10 | 20 |
| 1-82 | 63 | 100 | 100 | 100 | 100 | 100 | 100 | — | 80 | 60 | 40 | 10 |
| 1-83 | 63 | 90 | 100 | 100 | 100 | 100 | 80 | — | 60 | 10 | 20 | 60 |
| 1-84 | 63 | 0 | 50 | 20 | 70 | 0 | 0 | — | 10 | 0 | 0 | 0 |
| 1-85 | 63 | 60 | 100 | 70 | 100 | 70 | 30 | — | 10 | 0 | 10 | 0 |
| 1-86 | 125 | 0 | 0 | 0 | 30 | 0 | 0 | — | 0 | 0 | 0 | 0 |
| 1-87 | 63 | 100 | 100 | 100 | 100 | 98 | 80 | — | 60 | 10 | 0 | 40 |
| 1-88 | 63 | 50 | 98 | 70 | 100 | 80 | 70 | — | 10 | 0 | 0 | 40 |
| 1-90 | 63 | 98 | 100 | 100 | 100 | 98 | 100 | — | 60 | 50 | 30 | 40 |
| 1-251 | 63 | 0 | 20 | 20 | 100 | 20 | 30 | — | 10 | 0 | 0 | 0 |
| 1-252 | 63 | 30 | 40 | 50 | 100 | 20 | 50 | — | 10 | 10 | 0 | 0 |
| 1-253 | 63 | 20 | 70 | 50 | 100 | 30 | 40 | — | 10 | 0 | 0 | 0 |
| 1-254 | 63 | 60 | 60 | 50 | 100 | 60 | 50 | — | 20 | 0 | 0 | 0 |
| 1-255 | 63 | 0 | 10 | 10 | 70 | 0 | 0 | — | 0 | 0 | 0 | 0 |
| 1-256 | 63 | 60 | 90 | 70 | 100 | 60 | 70 | — | 30 | 10 | 0 | 0 |
| 1-257 | 63 | 30 | 10 | 10 | 100 | 60 | 10 | — | 20 | 0 | 0 | 0 |
| 1-258 | 63 | 10 | 70 | 30 | 100 | 70 | 70 | — | 40 | 0 | 0 | 0 |
| 1-259 | 63 | 10 | 20 | 30 | 100 | 30 | 0 | — | 0 | 10 | 0 | 0 |
| 1-260 | 63 | 60 | 100 | 100 | 100 | 70 | 40 | — | 50 | 30 | 10 | 0 |
| 1-261 | 63 | 80 | 100 | 98 | 100 | 100 | 80 | — | 40 | 10 | 0 | 0 |
| 1-262 | 63 | 0 | 30 | 30 | 100 | 30 | 20 | — | 10 | 0 | 0 | 0 |
| 1-263 | 63 | 90 | 98 | 100 | 100 | 100 | 100 | — | 40 | 30 | 0 | 10 |
| 1-264 | 63 | 100 | 100 | 60 | 100 | 100 | 80 | — | 50 | 20 | 0 | 0 |
| 1-265 | 63 | 20 | 100 | 70 | 100 | 100 | 100 | — | 10 | 20 | 0 | 0 |
| 1-266 | 63 | 60 | 100 | 80 | 100 | 100 | 50 | — | 10 | 40 | 0 | 0 |
| 1-267 | 63 | 70 | 100 | 95 | 100 | 80 | 100 | — | 30 | 20 | 0 | 0 |
| 1-268 | 63 | 40 | 100 | 80 | 100 | 70 | 80 | — | 30 | 20 | 0 | 0 |
| 1-269 | 63 | 80 | 100 | 100 | 100 | 100 | 80 | — | 40 | 40 | 10 | 0 |
| 1-271 | 125 | 70 | 100 | 90 | 100 | 100 | 40 | — | 60 | 10 | 20 | 20 |
| 1-273 | 63 | 0 | 30 | 20 | 80 | — | 10 | — | 10 | 0 | 0 | 0 |

### TEST EXAMPLE 2

Upland field soil was put into a 1/170,000 ha pot, and seeds of various plants were sown. Then, when the plants reached predetermined leaf stages {1. barnyardgrass (Echinochloa crus-galli L.), ECHCG: 1.1-2.1 leaf stage, 2. crabgrass (Digitaria sanguinalis L.), DIGSA: 1.0-2.0 leaf stage, 3. green foxtail (Setaria viridis L.), SETVI: 1.0-2.2 leaf stage, 4. redroot pigweed (Amaranthus retroflexus L.), AMARE: 0.1-1.5 leaf stage, 5. prickly sida (Sida spinosa L.), SIDSP: 0.1-0.6 leaf stage, 6. velvetleaf (Abutilon theophrasti), ABUTH: 0.1-0.6 leaf stage, 7. common cocklebur (Xanthium strumarium L.), XANST: 0.1 leaf stage, 8. rice (Oryza sativa L.), ORYSA; 1.0-2 leaf stage, 9. wheat (Triticum aestivum L.), TRZAX: 2.3-3.5 leaf stage, 10. corn (Zea mays L.), ZEAMXN 2.1-2.6 leaf stage, 11. soybean (Glycine max Merr.), GLXMA: primary leaf stage}, a wettable powder or emulsifiable concentrate having the compound of the present invention formulated in accordance with a usual formulation method, was weighed so that the active ingredient would be a predetermined amount, and diluted with water in an amount of 500 L/ha. To the diluted solution, 0.1% (v/v) of an agricultural spreader was added. The herbicide adjusted was applied by a small size sprayer for foliage treatment. On the 20^{th} to 23^{rd} day after the application of the herbicide, the growth of the respective plants was visually observed, and the herbicidal effects were evaluated by growth controlling degrees (%) ranging from 0 (equivalent to the untreated control) to 100 (complete kill), whereby the results shown in Table 5, were obtained. Compound Nos. in Table 5 correspond to Compound Nos. in Table 1 and 2 given hereinbefore.

TABLE 5
Post-emergence Herbicidal Activity

| Compound | Rate | | | | | | | | | | | |
|---|---|---|---|---|---|---|---|---|---|---|---|---|
| No. | g a.i./ha | ECHCO | DIGSP | SETVI | AMARE | SIDSP | ABUTH | XANST | ORYSA | TRZAX | ZEAMX | GLXMA |
| 1-3 | 63 | 70 | 95 | 100 | 100 | 100 | 100 | — | 80 | 40 | 70 | 80 |
| 1-4 | 63 | 100 | 100 | 100 | 100 | 100 | 100 | — | 50 | 50 | 80 | 80 |
| 1-6 | 63 | 60 | 70 | 100 | 100 | 100 | 100 | 95 | 40 | 30 | 30 | 90 |
| 1-7 | 63 | 50 | 10 | 70 | — | 100 | 100 | — | 40 | 10 | 40 | 50 |
| 1-8 | 63 | 70 | 60 | 100 | 100 | 100 | 100 | — | 60 | 50 | 40 | 70 |
| 1-9 | 63 | 80 | 98 | 100 | 100 | 100 | 100 | 70 | 80 | 40 | 70 | 90 |
| 1-10 | 63 | 90 | 60 | 100 | 100 | 100 | 100 | 100 | 70 | 40 | 40 | 50 |
| 1-11 | 63 | 70 | 40 | 100 | 100 | 100 | 100 | 30 | 40 | 20 | 30 | 50 |
| 1-12 | 63 | 70 | 30 | 95 | 100 | 100 | 100 | 50 | 40 | 20 | 10 | 40 |
| 1-13 | 63 | 80 | 70 | 90 | 100 | 100 | 100 | 50 | 70 | 30 | 40 | 50 |
| 1-14 | 63 | 98 | 98 | 100 | 100 | 100 | 100 | 100 | 40 | 40 | 40 | 60 |
| 1-15 | 63 | 90 | 70 | 100 | 100 | 100 | 100 | — | 80 | 50 | 50 | 50 |
| 1-16 | 63 | 80 | 80 | 100 | — | 100 | 100 | — | 80 | 50 | 70 | 95 |
| 1-18 | 63 | 70 | 70 | 80 | 100 | 100 | 100 | — | 60 | 10 | 60 | 60 |
| 1-19 | 63 | 30 | 30 | 30 | 100 | 90 | 90 | — | 20 | 10 | 0 | 60 |
| 1-20 | 63 | 10 | 20 | 70 | 100 | 90 | 60 | — | 50 | 10 | 40 | 50 |
| 1-21 | 31 | 80 | 60 | 95 | 100 | 100 | 100 | — | 90 | 40 | 90 | 70 |
| 1-22 | 63 | 100 | 100 | 100 | 100 | 100 | 100 | — | 95 | 40 | 90 | 98 |
| 1-23 | 63 | 98 | 90 | 100 | 100 | 100 | 100 | — | 90 | 40 | 80 | 98 |
| 1-24 | 63 | 100 | 98 | 100 | 100 | 100 | 100 | — | 98 | 50 | 90 | 100 |
| 1-25 | 63 | 98 | 100 | 100 | 100 | 100 | 100 | — | 90 | 40 | 90 | 98 |
| 1-26 | 63 | 95 | 60 | 100 | 100 | 100 | 100 | — | 80 | 30 | 40 | 70 |
| 1-27 | 63 | 100 | 100 | 100 | 100 | 70 | 100 | — | 80 | 30 | 60 | 70 |
| 1-28 | 63 | 100 | 100 | 100 | 100 | 90 | 100 | — | 95 | 40 | 90 | 98 |
| 1-29 | 63 | 100 | 100 | 100 | 100 | 100 | 95 | — | 80 | 50 | 60 | 100 |
| 1-30 | 63 | 100 | 100 | 100 | 100 | 100 | 100 | — | 90 | 50 | 60 | 95 |
| 1-31 | 63 | 80 | 80 | 95 | 100 | 100 | 100 | — | 60 | 20 | 40 | 60 |
| 1-32 | 63 | 95 | 70 | — | 100 | 100 | 100 | — | 90 | 50 | 95 | 80 |
| 1-33 | 63 | 80 | 70 | 98 | 100 | 100 | 100 | — | 50 | 30 | 60 | 60 |
| 1-34 | 63 | 70 | 70 | 100 | 100 | 100 | 100 | — | 40 | 30 | 50 | 70 |
| 1-35 | 63 | 80 | 70 | 95 | 100 | 100 | 100 | — | 60 | 40 | 60 | 80 |
| 1-36 | 63 | 50 | 60 | 60 | 100 | 100 | 100 | — | 20 | 10 | 0 | 50 |
| 1-37 | 63 | 98 | 80 | — | 100 | 100 | 100 | — | 90 | 50 | 70 | 98 |
| 1-38 | 63 | 50 | 20 | 50 | 100 | 100 | 100 | — | 40 | 10 | 10 | 30 |
| 1-39 | 63 | 10 | 10 | 30 | 100 | — | 100 | — | 20 | 10 | 0 | 0 |
| 1-40 | 63 | 100 | 80 | 100 | — | 100 | 100 | — | 100 | 50 | 70 | 95 |
| 1-41 | 63 | 20 | 30 | 40 | — | 100 | 100 | — | 30 | 30 | 0 | 40 |
| 1-42 | 63 | 30 | 30 | 50 | 100 | 70 | 95 | — | 20 | 20 | 0 | 10 |
| 1-43 | 63 | 40 | 20 | 70 | 100 | — | 100 | — | 30 | 10 | 10 | 40 |
| 1-44 | 63 | 50 | 60 | 80 | 100 | — | 100 | — | 50 | 20 | 10 | 40 |
| 1-45 | 63 | 95 | 70 | 90 | 100 | — | 100 | — | 80 | 40 | 40 | 60 |
| 1-50 | 63 | 100 | 90 | — | 100 | 100 | 100 | — | 95 | 70 | 80 | 95 |
| 1-52 | 63 | 50 | 30 | 30 | — | 90 | 80 | — | 40 | 10 | 10 | 30 |
| 1-53 | 63 | 100 | 100 | 100 | 100 | 100 | 100 | — | 95 | 40 | 100 | 95 |
| 1-54 | 63 | 90 | 70 | 80 | 100 | 100 | 100 | — | 98 | 30 | 50 | 60 |
| 1-55 | 63 | 60 | 0 | 30 | 100 | 100 | 100 | — | 50 | 10 | 10 | 30 |
| 1-56 | 63 | 90 | 98 | 100 | 100 | 100 | 100 | — | 90 | 50 | 80 | 100 |
| 1-57 | 63 | 100 | 100 | 100 | 100 | 100 | 100 | — | 95 | 40 | 90 | 90 |
| 1-58 | 63 | 100 | 100 | 100 | 100 | 100 | 100 | 100 | 70 | 60 | 100 | 95 |
| 1-59 | 63 | 100 | 98 | 100 | 100 | 100 | 100 | 100 | 40 | 50 | 80 | 95 |
| 1-60 | 63 | 100 | 80 | 100 | 100 | 100 | 100 | 100 | 40 | 40 | 50 | 70 |
| 1-61 | 63 | 100 | 100 | 100 | 100 | 100 | 100 | — | 80 | 60 | 80 | 80 |
| 1-62 | 63 | 100 | 100 | 100 | 100 | 100 | 100 | — | 80 | 30 | 80 | 80 |
| 1-63 | 63 | 100 | 90 | 100 | 100 | 100 | 100 | — | 60 | 40 | 70 | 60 |
| 1-64 | 63 | 90 | 70 | 100 | 100 | 100 | 100 | — | 30 | 30 | 30 | 50 |
| 1-65 | 63 | 0 | 0 | 0 | 10 | 0 | 0 | — | 0 | 0 | 0 | 10 |
| 1-66 | 63 | 20 | 40 | 60 | — | 100 | 100 | — | 50 | 20 | 40 | 60 |
| 1-67 | 63 | 70 | 70 | — | 100 | 100 | 100 | — | 60 | 30 | 30 | 70 |
| 1-68 | 63 | 70 | — | 100 | — | 100 | 100 | — | 60 | 20 | 50 | 60 |
| 1-69 | 63 | 100 | 70 | 100 | 100 | 100 | 100 | — | 95 | 50 | 95 | 95 |
| 1-70 | 63 | 80 | 60 | — | 100 | 100 | 100 | — | 95 | 30 | 80 | 80 |
| 1-71 | 63 | 100 | — | — | — | 100 | 100 | — | 80 | 60 | 70 | 80 |
| 1-72 | 63 | 80 | 80 | — | 100 | 100 | 100 | — | 60 | 20 | 40 | 70 |
| 1-73 | 63 | 100 | 10 | 70 | — | 100 | 100 | — | 50 | 50 | 10 | 50 |
| 1-74 | 63 | 98 | 70 | 100 | 100 | 100 | 100 | — | 95 | 50 | 30 | 60 |
| 1-75 | 63 | 100 | 50 | 100 | 100 | 100 | 100 | — | 80 | 50 | 50 | 60 |
| 1-76 | 63 | 100 | 70 | 80 | 100 | — | 100 | — | 80 | 40 | 90 | 70 |
| 1-77 | 63 | 70 | 60 | 95 | — | 100 | 100 | — | 40 | 30 | 60 | 60 |
| 1-81 | 125 | 100 | 100 | 100 | 100 | 100 | 100 | 100 | 70 | 100 | 90 | 80 |
| 1-82 | 63 | 100 | 100 | 100 | 100 | 100 | 100 | — | 70 | 60 | 70 | 90 |
| 1-83 | 63 | 100 | 100 | 100 | 100 | 100 | 100 | — | 50 | 10 | 80 | 60 |
| 1-84 | 63 | 20 | 0 | 10 | — | 70 | 80 | — | 10 | 0 | 20 | 50 |
| 1-85 | 63 | 80 | 80 | 100 | 100 | 95 | 100 | — | 60 | 40 | 40 | 60 |
| 1-86 | 63 | 0 | 30 | 10 | 100 | 60 | 0 | — | 0 | 0 | 0 | 40 |
| 1-87 | 63 | 100 | 100 | 100 | 100 | 100 | 100 | — | 70 | 50 | 100 | 95 |
| 1-88 | 63 | 100 | 98 | 100 | 100 | 100 | 100 | — | 30 | 30 | 60 | 60 |
| 1-90 | 31 | 100 | 100 | 100 | 100 | 100 | 100 | — | 98 | 95 | 98 | 98 |
| 1-251 | 63 | 60 | 70 | 60 | 100 | 95 | 95 | — | 10 | 20 | 10 | 40 |
| 1-252 | 63 | 100 | 95 | 100 | 100 | 100 | 100 | — | 50 | 50 | 50 | 80 |
| 1-253 | 63 | 80 | 30 | 100 | 100 | 100 | 100 | — | 70 | 50 | 40 | 80 |
| 1-254 | 63 | 80 | 60 | 95 | 100 | 100 | 100 | — | 90 | 30 | 30 | 70 |
| 1-255 | 63 | 50 | 30 | 50 | 100 | 100 | 100 | — | 40 | 10 | 20 | 50 |
| 1-256 | 63 | 60 | 60 | 90 | — | 100 | 100 | — | 80 | 60 | 30 | 60 |
| 1-257 | 63 | 60 | 50 | 70 | — | 100 | 100 | — | 40 | 50 | 30 | 40 |
| 1-258 | 63 | 60 | 40 | 60 | — | 100 | 100 | — | 40 | 10 | 10 | 20 |
| 1-259 | 63 | 50 | 30 | 50 | 100 | — | 100 | — | 10 | 0 | 0 | 10 |
| 1-260 | 63 | 100 | 95 | 100 | 100 | — | 100 | — | 60 | 40 | 60 | 70 |
| 1-261 | 63 | 100 | 95 | 100 | — | 100 | 100 | — | 70 | 30 | 40 | 70 |
| 1-262 | 63 | 60 | 40 | 80 | 100 | — | 100 | — | 30 | 30 | 40 | 50 |
| 1-263 | 63 | 98 | 98 | 100 | 100 | — | 100 | — | 70 | 30 | 60 | 50 |
| 1-264 | 63 | 80 | 100 | 100 | 100 | — | 100 | — | 80 | 40 | 50 | 70 |
| 1-265 | 63 | 60 | 60 | 80 | — | 100 | 95 | — | 40 | 30 | 30 | 50 |
| 1-273 | 63 | 30 | 20 | — | 100 | 90 | 98 | — | 10 | 20 | 10 | 60 |
| 2-21 | 31 | 100 | 95 | 100 | 100 | 100 | 100 | — | 90 | 40 | 80 | 90 |

### TEST EXAMPLE 3

Paddy field soil was put into a 1/1,000,000 ha pot and seeds of barnyardgrass (Echinochiloa oryzicola: ECHOR) and japanese bulrush (Scirpus juncoides: SCPJO) were sown and slightly covered with soil. Then the pot was left to stand still in a greenhouse in a state where the depth of flooding water was from 0.5 to 1 cm, and one day later, tubers of japanese ribbon wapato (Sagittaria pygmaea: SA GPY) were planted. Thereafter, the depth of flooding water was maintained at a level of from 3 to 4 cm, and when barnyardgrass and japanese bulrush reached a 0.5 leaf stage, an aqueous diluted solution of a wettable powder or emulsifiable concentrate having the compound of the present invention formulated in accordance with a usual formulation method, was uniformly applied under submerged condition by a pipette so that the dose of the active ingredient would be at a predetermined level. On the other hand, paddy filed soil was put into a 1/1,000,000 ha pot and puddled and leveled, and the depth of flooding water was from 3 to 4 cm. One day later, rice (Oryza sativa L.: ORYSA) of 2 leaf stage was transplanted in a depth of 3 cm. On the 4^{th} day after the transplantation, the compound of the present invention was applied in the same manner as described above. On the 14^{th} day after the application of the herbicide, the growth of barnyardgrass, japanese burlush and japanese ribbon wapato was visually observed and on the 21^{st} day after the application of the herbicide, the growth of rice was visually observed, and the herbicidal effects were evaluated by growth controlling degrees (%) ranging from 0 (equivalent to the untreated control) to 100 (complete kill), whereby the results shown in Table 6, were obtained. Compound Nos. in Table 6 correspond to Compound Nos. in Table 1 and 2 given hereinbefore.

TABLE 6
Water Application Herbicidal Activity

| Compound | Rate | | | | |
|---|---|---|---|---|---|
| No. | g a.i./ha | ECHOR | SCPJO | SAGPY | ORYSA |
| 1-3 | 63 | 100 | 98 | 100 | 80 |
| 1-4 | 63 | 100 | 100 | 98 | 70 |
| 1-6 | 63 | 90 | 60 | 30 | 50 |
| 1-7 | 63 | 95 | 60 | 0 | 20 |
| 1-8 | 63 | 80 | 60 | 20 | 30 |
| 1-9 | 63 | 100 | 100 | 100 | 30 |
| 1-10 | 63 | 100 | 40 | 40 | 10 |
| 1-11 | 63 | 100 | 40 | 40 | 35 |
| 1-12 | 63 | 95 | 50 | 30 | 35 |
| 1-13 | 63 | 95 | 40 | 0 | 10 |
| 1-14 | 63 | 100 | 90 | 98 | 50 |
| 1-15 | 63 | 100 | 90 | 98 | 50 |
| 1-16 | 63 | 100 | 98 | 100 | 70 |
| 1-18 | 63 | 100 | 40 | 50 | 30 |
| 1-19 | 63 | 70 | 30 | 20 | 30 |
| 1-20 | 63 | 90 | 20 | 0 | 30 |
| 1-21 | 63 | 100 | 70 | 100 | 50 |
| 1-22 | 63 | 100 | 95 | 98 | 40 |
| 1-23 | 63 | 100 | 80 | 98 | 40 |
| 1-24 | 63 | 100 | 80 | 90 | 60 |
| 1-25 | 63 | 98 | 95 | 100 | 60 |
| 1-26 | 63 | 100 | 70 | 100 | 60 |
| 1-27 | 63 | 100 | 70 | 98 | 50 |
| 1-28 | 63 | 100 | 80 | 100 | 50 |
| 1-29 | 63 | 100 | 50 | 60 | 50 |
| 1-30 | 63 | 100 | 98 | 100 | 60 |
| 1-31 | 63 | 100 | 60 | 95 | 40 |
| 1-32 | 63 | 100 | 70 | 100 | 50 |
| 1-33 | 63 | 100 | 40 | 98 | 35 |
| 1-34 | 63 | 100 | 50 | 80 | 30 |
| 1-35 | 63 | 100 | 70 | 60 | 30 |
| 1-36 | 63 | 100 | 40 | 70 | 35 |
| 1-52 | 63 | 100 | 50 | 0 | 20 |
| 1-53 | 63 | 100 | 100 | 100 | 70 |
| 1-54 | 63 | 98 | 30 | 30 | 40 |
| 1-55 | 63 | 100 | 95 | 100 | 50 |
| 1-56 | 63 | 100 | 95 | 80 | 35 |
| 1-57 | 63 | 100 | 100 | 100 | 50 |
| 1-58 | 63 | 100 | 100 | 100 | 70 |
| 1-59 | 63 | 100 | 80 | 60 | 40 |
| 1-60 | 63 | 100 | 60 | 60 | 30 |
| 1-61 | 63 | 100 | 90 | 100 | 95 |
| 1-62 | 63 | 100 | 100 | 100 | 70 |
| 1-63 | 63 | 100 | 70 | 70 | 40 |
| 1-64 | 63 | 100 | 70 | — | 40 |
| 1-65 | 63 | 50 | 0 | 0 | 20 |
| 1-66 | 63 | 90 | 30 | 0 | — |
| 1-67 | 63 | 100 | 100 | 100 | — |
| 1-68 | 63 | 100 | 95 | 80 | — |
| 1-49 | 63 | 100 | 60 | 100 | — |
| 1-70 | 63 | 100 | 80 | 100 | — |
| 1-71 | 63 | 100 | 70 | 100 | — |
| 1-72 | 63 | 100 | 60 | 100 | — |
| 1-81 | 63 | 100 | 100 | 95 | 35 |
| 1-82 | 63 | 100 | 98 | 100 | 60 |
| 1-83 | 63 | 100 | 95 | 80 | 50 |
| 1-84 | 63 | 60 | 90 | 95 | 30 |
| 1-85 | 63 | 100 | 60 | 70 | 70 |
| 1-86 | 63 | 60 | 50 | — | 10 |
| 1-87 | 63 | 100 | 100 | 100 | 70 |
| 1-88 | 63 | 100 | 80 | 60 | 20 |
| 1-90 | 63 | 100 | 98 | 98 | 50 |
| 1-252 | 63 | 100 | 30 | 60 | 10 |
| 1-273 | 63 | 70 | 0 | 0 | 30 |
| 2-21 | 63 | 100 | 98 | 100 | 40 |

1. A compound represented by the formula (I) or its salt 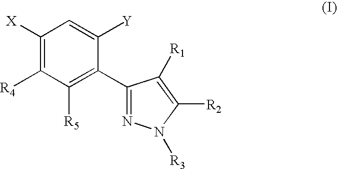
wherein
X and Y are independent of each other and are selected from the group consisting of halogen, cyano, nitro, (C₁₋₆)alkyl, (C₁₋₆)haloalkyl, (C₁₋₆)alkoxy and (C₁₋₆)haloalkoxy;
R₁ is hydrogen, halogen, cyano, nitro, (C₁₋₆)alkyl, (C₁₋₆)haloalkyl, (C₁₋₆)alkoxy or (C₁₋₆)haloalkoxy;
R₂ is (C₁₋₆)haloalkoxy;
R₃ is (C₁₋₆)alkyl, (C₁₋₆)haloalkyl, (C₁₋₆)alkoxy or (C₁₋₆)haloalkoxy;
R₄ is selected from the group consisting of halogen, cyano, nitro, hydroxy, carboxyl, formyl, isocyanate, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((C₂₋₆)alkynylthio)thiocarbonyl, (C₁₋₆)alkylcarbonyloxy, (C₂₋₆)alkenylcarbonyloxy) (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy; ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy, ((C₂₋₆)alkynyl)thiocarbonyloxy, ((C₁₋₆)alkoxy)thiocarbonyloxy) ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₂₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₂₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₆)alkynylthio)thiocarbonylthio, (C₂₋₆)alkenylsulfonyloxy, (C₂₋₆)alkynylsulfonyloxy, (C₃₋₆)cycloalkyl, (C₃₋₆)cycloalkenyl, (C₃₋₆)cycloalkyloxy, (C₃₋₆)cycloalkenyloxy, (C₃₋₆)cycloalkylthio, (C₃₋₆)cycloalkenylthio, (C₃₋₆)cycloalkylsulfinyl, (C₃₋₆)cycloalkenylsulfinyl, (C₃₋₆)cycloalkylsulfonyl, (C₃₋₆)cycloalkenylsulfonyl, (C₃₋₆)cycloalkylcarbonyl, (C₁₋₆)cycloalkenylcarbonyl, aryl, aryloxy, arylcarbonyl, aryloxycarbonyl, (arylthio)carbonyl, arylthio, arylsulfinyl arylsulfonyl, heterocyclyl, heterocyclyloxy, heterocyclylcarbonyl heterocyclyloxycarbonyl, (heterocyclylthio)carbonyl, heterocyclylthio, heterocyclylsulfinyl, heterocyclylsulfonyl, —CR₆═NOR₇, —CONR₇R₈, —CO₂NR₇R₈, —NR₆NR₇R₈, —NR₆N═CR₇R₈ and —N═CR₇R₈,
where any of these groups may be substituted with one or more of the groups selected from the group consisting of halogen, cyano, nitro, amino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, (C₁₋₆)alkylsulfinylcarbonyl, (C₁₋₆)haloalkylsulfinylcarbonyl, (C₁₋₆)alkylsulfonylcarbonyl, (C₁₋₆)haloalkylsulfonylcarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl and heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy; (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, amino, (C₁₋₆)alkylamino and di(C₁₋₆),
R₅ is selected from the group consisting of halogen, cyano, nitro, carboxyl, formyl, isocyanate, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₁₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((C₂₋₆)alkynylthio)thiocarbonyl, (C₁₋₆)alkylcarbonyloxy, (C₂₋₆)alkenylcarbonyloxy, (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy, ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy, ((C₂₋₆)alkynyl)thiocarbonyloxy, ((C₁₋₆)alkoxy)thiocarbonyloxy, ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₂₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₂₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₆)alkynylthio)thiocarbonylthio, (C₁₋₆)alkylsulfonyloxy, (C₂₋₆)alkenysulfonyloxy, (C₂₋₆)alkynylsulfonyloxy, (C₃₋₆)cycloakyl, (C₃₋₆)cycloalkenyl, (C₃₋₆)cycloalkyloxy, (C₃₋₆)cycloalkenyloxy, (C₃₋₆)cycloalkylthio, (C₃₋₄)cycloalkenylthio, (C₃₋₆)cycloalkylsulfinyl, (C₃₋₆)cycloalkenylsulfinyl, (C₃₋₆)cycloalkylsulfonyl, (C₃₋₆)cycloalkenylsulfonyl, (C₃₋₄)cycloalkylcarbonyl, (C₃₋₆)cycloalkenylcarbonyl, aryl, aryloxy, arylcarbonyl, aryloxycarbonyl, (arylthio)carbonyl, arylthio, arylsulfinyl, arylsulfonyl, heterocyclyl, heterocyclyloxy, heterocyclylcarbonyl, heterocyclyloxycarbonyl, (heterocyclylthio)carbonyl, heterocyclylthio, heterocyclylsulfinyl, heterocyclylsulfonyl, —CR₆═NOR₇, —CONR₇R₈, —CO₂NR₇R₈, —NR₇R₈, —NR₆NR₇R₈, —CO₂N═CR₇R₈, —NR₆CR₇R₈, —N═CR₇R₈ and —CO(halogen),
where any of these groups may be substituted with one or more of the groups selected from the group consisting of halogen, cyano, nitro, amino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, (C₁₋₆)alkylsulfinylcarbonyl, (C₁₋₆)haloalkylsulfinylcarbonyl, (C₁₋₆)alkylsulfonylcarbonyl, (C₁₋₆)haloalkylsulfonylcarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl and heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, amino, (C₁₋₆)alkylamino and di(C₁₋₆);
R₆, R₇ and R₈ are independent of each other and are selected from the group consisting of hydrogen, halogen, cyano, nitro, amino, carboxyl, formyl, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₂₋₆)alkenylcarbonyl, (C₂₋₆)alkynylcarbonyl, (C₁₋₆)alkoxycarbonyl, (C₂₋₆)alkenyloxycarbonyl, (C₂₋₆)alkynyloxycarbonyl, ((C₁₋₆)alkylthio)carbonyl, ((C₂₋₆)alkenylthio)carbonyl, ((C₂₋₆)alkynylthio)carbonyl, ((C₁₋₆)alkyl)thiocarbonyl, ((C₂₋₆)alkenyl)thiocarbonyl, ((C₂₋₆)alkynyl)thiocarbonyl, ((C₁₋₆)alkoxy)thiocarbonyl, ((C₂₋₆)alkenyloxy)thiocarbonyl, ((C₂₋₆)alkynyloxy)thiocarbonyl, ((C₁₋₆)alkylthio)thiocarbonyl, ((C₂₋₆)alkenylthio)thiocarbonyl, ((C₂₋₆)alkynylthio)thiocarbonyl, aminocarbonyl, (C₁₋₆)alkylaminocarbonyl, di(C₁₋₆)alkylaminocarbonyl, (amino)thiocarbonyl, ((C₁₋₆)alkylamino)thiocarbonyl, (di(C₁₋₆)alkylamino)thiocarbonyl, (C₁₋₆)alkylcarbonyloxy, (C₂₋₆)alkenylcarbonyloxy, (C₂₋₆)alkynylcarbonyloxy, (C₁₋₆)alkoxycarbonyloxy, (C₂₋₆)alkenyloxycarbonyloxy, (C₂₋₆)alkynyloxycarbonyloxy, ((C₁₋₆)alkylthio)carbonyloxy, ((C₂₋₆)alkenylthio)carbonyloxy, ((C₂₋₆)alkynylthio)carbonyloxy, ((C₁₋₆)alkyl)thiocarbonyloxy, ((C₂₋₆)alkenyl)thiocarbonyloxy, ((C₂₋₆)alkynyl)thiocarbonyloxy, ((C₁₋₆)alkoxy)thiocarbonyloxy, ((C₂₋₆)alkenyloxy)thiocarbonyloxy, ((C₂₋₆)alkynyloxy)thiocarbonyloxy, ((C₁₋₆)alkylthio)thiocarbonyloxy, ((C₂₋₆)alkenylthio)thiocarbonyloxy, ((C₂₋₆)alkynylthio)thiocarbonyloxy, (C₁₋₆)alkylcarbonylthio, (C₂₋₆)alkenylcarbonylthio, (C₂₋₆)alkynylcarbonylthio, (C₁₋₆)alkoxycarbonylthio, (C₂₋₆)alkenyloxycarbonylthio, (C₂₋₆)alkynyloxycarbonylthio, ((C₁₋₆)alkylthio)carbonylthio, ((C₂₋₆)alkenylthio)carbonylthio, ((C₂₋₆)alkynylthio)carbonylthio, ((C₁₋₆)alkyl)thiocarbonylthio, ((C₂₋₆)alkenyl)thiocarbonylthio, ((C₂₋₆)alkynyl)thiocarbonylthio, ((C₁₋₆)alkoxy)thiocarbonylthio, ((C₂₋₆)alkenyloxy)thiocarbonylthio, ((C₂₋₆)alkynyloxy)thiocarbonylthio, ((C₁₋₆)alkylthio)thiocarbonylthio, ((C₂₋₆)alkenylthio)thiocarbonylthio, ((C₂₋₆)alkynylthio)thiocarbonylthio, (C₃₋₆)cycloalkyl, (C₃₋₆)cycloalkenyl, (C₃₋₆)cycloalkylsulfinyl, (C₃₋₆)cycloalkenylsulfinyl, (C₃₋₆)cycloalkylsulfonyl, (C₁₋₆)cycloalkenylsulfonyl, (C₃₋₆)cycloalkylcarbonyl, (C₃₋₆)cycloalkenylcarbonyl, aryl aryloxy, arylthio, arylsulfinyl, arylsulfonyl, arylcarbonyl, heterocyclyl, heterocyclyloxy, heterocyclylsulfinyl, heterocyclylsulfonyl, heterocyclylcarbonyl, —CO₂N═CRaRb, —CO—W-Q, —CO—(CH₂)ₘ—W-Q, —CO—W—(CH₂)ₘ-Q and —CO—(CH₂)ₘ—W—(CH₂)ᵣ-Q,
where any of these groups may be substituted with one or more of the groups selected from the group consisting of halogen, cyano, nitro, amino, (C₁₋₆)alkylamino, (C₁₋₆)dialkylamino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl heterocyclyl, heterocyclyloxy, heterocyclylthio, heterocyclylsulfinyl, heterocyclylsulfonyl and heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino;
when R₇ and R₈ are taken together with the atoms to which they are attached, they represent a four to seven membered substituted or unsubstituted ring optionally containing C(O), O, S, S(O), S(O)₂ or N with following optional substitutions, one to three halogen, cyano, nitro, amino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylthio, (C₁₋₆)haloalkylthio, (C₁₋₆)alkylsulfinyl, (C₁₋₆)haloalkylsulfinyl, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, ((C₁₋₆)alkylthio)carbonyl, ((C₁₋₆)haloalkylthio)carbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkoxycarbonyloxy, (C₁₋₆)haloalkoxycarbonyloxy, ((C₁₋₆)alkylthio)carbonyloxy, ((C₁₋₆)haloalkylthio)carbonyloxy, (C₁₋₆)alkylsulfonyloxy, (C₁₋₆)haloalkylsulfonyloxy, (C₃₋₆)cycloalkyl, (C₃₋₆)halocycloalkyl, aryl, aryloxy, arylthio, arylsulfinyl, arylsulfonyl, arylcarbonyl, heterocyclyl, heterocyclyloxy, heterocyclylthio, heterocyclylsulfinyl, heterocyclylsulfonyl or heterocyclylcarbonyl, wherein aryl and heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino;
wherein
Ra and Rb are independent of each other and are selected from the group consisting of hydrogen, (C₁₋₆)alkyl, (C₁₋₆)haloalkyl and aryl, when Ra and Rb are taken together with atoms to which they are attached they represent a four to seven membered saturated ring;
W is oxygen, sulfur or —NRc;
Rc is hydrogen or (C₁₋₄)alkyl;
Q is aryl or heterocyclyl, wherein the aryl and the heterocyclyl are optionally substituted by one or more substituents which are the same or different and selected from the group consisting of halogen, cyano, nitro, carboxyl, hydroxy, mercapto, (C₁₋₆)alkyl, (C₁₋₆)haloalkyl, (C₁₋₆)alkoxy, (C₁₋₆)haloalkoxy, amino, (C₁₋₆)alkylamino and di(C₁₋₆)alkylamino;
m is integer from 1 to 6;
r is integer from 1 to 6;
with proviso that 4-chloro-3-(2-amino-4-chloro-6-fluoro-3-hydroxyphenyl)-5-difluoromethoxy-1-methyl-1H-pyrazole, N-[3-chloro-6-[4-chloro-5-(difluoromethoxy)-1-methyl-1H-pyrazol-3-yl]-5-fluoro-2-methoxyphenyl]-benzamide and [3-chloro-6-[4-chloro-5-(difluoromethoxy)-1-methyl-1H-pyrazol-3-yl]-5-fluoro-2-methoxyphenyl]-carbamic acid (3-nitrophenyl)methyl ester are excluded.

2. A compound or its salt according to the claim 1 wherein
X and Y are independent of each other and are selected from the group consisting of halogen and cyano;
R₁ is halogen, cyano, (C₁₋₆)haloalkyl or (C₁₋₆)haloalkoxy;
R₂ is (C₁₋₆)haloalkoxy;
R₃ is (C₁₋₆)alkyl;
R₄ is halogen, cyano, nitro, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkoxycarbonyl, (C₁₋₆)alkylcarbonyloxy, (C₃₋₆)cycloalkyl, (C₃₋₆)cycloalkylcarbonyl, aryloxy or heterocyclyloxy,
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy.

3. A compound or its salt according to the claim 1 wherein
X and Y are independent of each other and are selected from the group consisting of halogen and cyano;
R₁ is halogen, cyano, (C₁₋₆)haloalkyl or (C₁₋₆)haloalkoxy;
R₂ is (C₁₋₆)haloalkoxy;
R₃ is (C₁₋₆)alkyl;
R₄ is halogen, cyano, nitro, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkoxycarbonyl, (C₁₋₆)alkylcarbonyloxy, (C₃₋₆)cycloalkyl, (C₃₋₆)cycloalkylcarbonyl, aryloxy or heterocyclyloxy,
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy;
R₅ is halogen, cyano, nitro, carboxyl, formyl, thioisocyanate, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₁₋₆)alkoxycarbonyl, (C₁₋₆)alkylcarbonyloxy; (C₁₋₆)cycloalkyl, (C₃₋₆)cycloalkylcarbonyl, aryloxy, arylsulfonyl, heterocyclyloxy, —CONR₇R₈, —NR₇R₈, —N═CR₇R₈, —CO₂N═CR₇R₈ or —CO(halogen),
where any of these groups may be substituted with one or more of the groups selected from the group consisting of halogen, cyano, nitro, amino, hydroxy, mercapto, (C₁₋₆)alkyl, (C₁₋₆)haloalkyl, (C₁₋₆)alkoxy, (C₁₋₆)haloalkoxy, (C₁₋₆)alkylsufonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen and (C₁₋₆)alkoxy;
R₇ and R₈ are independent of each other and are selected from the group consisting of hydrogen, halogen, cyano, nitro, amino, carboxyl, formyl, (C₁₋₆)alkyl, (C₂₋₆)alkenyl, (C₂₋₆)alkynyl, (C₁₋₆)alkoxy, (C₂₋₆)alkenyloxy, (C₂₋₆)alkynyloxy, (C₁₋₆)alkylthio, (C₂₋₆)alkenylthio, (C₂₋₆)alkynylthio, (C₁₋₆)alkylsulfinyl, (C₂₋₆)alkenylsulfinyl, (C₂₋₆)alkynylsulfinyl, (C₁₋₆)alkylsulfonyl, (C₂₋₆)alkenylsulfonyl, (C₂₋₆)alkynylsulfonyl, (C₁₋₆)alkylcarbonyl, (C₁₋₆)alkenylcarbonyl, (C₁₋₆)alkoxycarbonyl, (C₁₋₆)alkynyloxycarbonyl, ((C₁₋₆)alkylthio)carbonyl, ((C₁₋₆)alkyl)thiocarbonyl, ((C₁₋₆)alkoxy)thiocarbonyl, aminocarbonyl, (C₁₋₆)alkylaminocarbonyl, di(C₁₋₆)alkylaminocarbonyl, (amino)thiocarbonyl, ((C₁₋₆)alkylamino)thiocarbonyl, (di(C₁₋₆)alkylamino)thiocarbonyl, (C₁₋₆)alkylcarbonyloxy, (C₃₋₆)cycloalkyl, (C₃₋₆)cycloalkylcarbonyl, aryl, aryloxy, arylthio, arylsulfinyl, arylsulfonyl, arylcarbonyl, heterocyclyl, heterocyclyloxy, heterocyclylcarbonyl, —CO₂N═CRaRb, —CO—W-Q, —CO—(CH₂)ₘ—W-Q, —CO—W—(CH₂)ₘ-Q and —CO—(CH₂)ₘ—W—(CH₂)ᵣ-Q,
where any of these groups may be substituted with one or more of the following group consisting of halogen, cyano, nitro, amino, (C₁₋₆)alkylamino, (C₁₋₆)dialkylamino, carboxyl, hydroxy, mercapto, (C₁₋₆)alkyl, (C₁₋₆)haloalkyl, (C₁₋₆)alkoxy, (C₁₋₆)haloalkoxy, (C₁₋₆)alkylsulfonyl, (C₁₋₆)haloalkylsulfonyl, (C₁₋₆)alkylcarbonyl, (C₁₋₆)haloalkylcarbonyl, (C₁₋₆)alkoxycarbonyl, (C₁₋₆)haloalkoxycarbonyl, aminocarbonyl, (C₁₋₆)alkylaminocarbonyl, di(C₁₋₆)alkylaminocarbonyl, (C₁₋₆)alkylcarbonyloxy, (C₁₋₆)haloalkylcarbonyloxy, (C₁₋₆)alkylsulfonyloxy, (C₁₋₆)haloalkylsulfonyloxy, (C₃₋₆)cycloalkyl, aryl, aryloxy, arylthio, arylsulfonyl, arylcarbonyl, heterocyclyl and heterocyclyloxy, wherein aryl and heterocyclyl are optionally substituted by one or more substituents which are the same or different and selected from the group consisting of halogen cyano, nitro, (C₁₋₆)alkyl and (C₁₋₆)alkoxy,
when R₇ and R₈ are taken together with the atoms to which they are attached, they represent a four to seven membered substituted or unsubstituted ring optionally containing C(O), O, S, S(O), S(O)₂ or N.

4. A herbicidal composition which comprises an effective amount of a compound or its salt of claim 1 and an agricultural additives.

5. A composition for the desiccation or defoliation of plants, comprising an effective amount of a compound or its salt of claim 1 and agricultural additives.

6. A herbicidal composition which comprises an effective amount of a compound or its salt of claim 1, one or more other herbicidal compounds and agricultural additives.

7. A herbicidal composition or herbicidal spray liquid, which comprises an effective amount of a compound or its salt of claim 1 and agricultural additives with one or more other herbicides.

8. A method for controlling the growth of undesired plant species in plantation crops which comprises applying to the locus of the crop a herbicidally effective amount of a compound or its salt of claim 1.

9. A method for controlling undesired vegetation in a crop field such as corn, peanut, cotton, wheat, sorghum, sunflower, soybean or rice by applying to the locus of the crop to be protect a herbicidally effective amount of a compound or its salt of claim 1.

10. A method for controlling weeds, which comprises applying to the locus to be protected a herbicidally effective amount of a compound or its salt of claim 1 in combination with one or more other herbicides for providing an additive or synergistic herbicidal effect.

11. A method to defoliate potato and cotton using a compound or its salt of claim 1.
